(19) United States
(12) Patent Application Publication
(10) Pub. No.: US 2026/0276444 A1
(43) Pub. Date: Sep. 17, 2026

(54) INFORMATION PROCESSING APPARATUS, INFORMATION PROCESSING METHOD, PROGRAM, IMAGE PROCESSING APPARATUS, AND IMAGE PROCESSING METHOD

(71) Applicant: Sony Semiconductor Solutions Corporation, Kanagawa (JP)

(72) Inventor: Seichi OTSUKI, Kanagawa (JP)

(73) Assignee: Sony Semiconductor Solutions Corporation, Kanagawa (JP)

(21) Appl. No.: 19/473,202

(22) PCT Filed: Apr. 18, 2024
(86) PCT No.: PCT/JP2024/015475

§ 371 Date: Oct. 7, 2025

Related U.S. Application Data
(60) Provisional application No. 63/462,016, filed on Apr. 26, 2023.

(51) Int. Cl. G01J 3/26; G01J 3/28

(52) U.S. Cl. CPC G01J 3/26; G01J 3/2823

(57) ABSTRACT

An information processing apparatus estimates a sensor input that is spectral information of input light to a spectral sensor on a basis of spectral reflectance information of a target subject and spectral information of a target light source; estimates a sensor output that is spectral information output by the spectral sensor according to the sensor input on a basis of spectral sensitivity information of the spectral sensor and the sensor input; and obtains an arithmetic algorithm that minimizes error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor.

### CROSS REFERENCE TO RELATED APPLICATIONS

This application claims priority to, and the benefit of, U.S. provisional patent application Ser. No. 63/462,016 filed on Apr. 26, 2023, incorporated herein by reference in its entirety.

### TECHNICAL FIELD

The present technology relates to an information processing apparatus, an information processing method, a program, an image processing apparatus, and an image processing method, and particularly relates to a technology for compensating spectral sensitivity variation of a spectral sensor.

### BACKGROUND ART

A spectral sensor (multi spectrum sensor) for obtaining a plurality of narrow-band images to be a wavelength characteristic analysis image for light from a subject, in other words, an analysis image of spectral information (spectral spectrum) of the subject is known, and an application for performing various analyses of the subject on the basis of spectral information obtained by the spectral sensor, such as analyzing a vegetation state of a plant or analyzing a human skin state on the basis of the plurality of narrow-band images, has been developed.

Here, in a case where the number of channels (the number of wavelength channels) of a plurality of narrow-band images desired to be obtained as spectral information of a subject is M, and the number of output wavelengths of the spectral sensor is N, M>N is satisfied in a general spectral camera. For example, M=41 or the like is set for N=8.

Therefore, in the spectral camera, narrow-band processing of obtaining narrow-band images of more wavelengths is usually performed on the basis of the output of the spectral sensor.

By the way, in the spectral sensor, it is very difficult to design an optical filter for separately receiving the light of N wavelengths described above, and there is a variation in sensitivity for each wavelength, and it is desired to compensate for this. Further, hereinafter, the sensitivity variation for each wavelength of the spectral sensor is referred to as “spectral sensitivity variation”.

In the past, the spectral sensitivity variation is compensated by a method in which the spectral sensitivity of the spectral sensor is measured in advance, and compensation processing using a function as a pseudo inverse matrix of the measured spectral sensitivity is performed on the output of the spectral sensor.

Note that PTLs 1 and 2 below can be cited as related techniques.

PTL 1 below discloses a soil analysis method for irradiating soil with light and analyzing characteristics of the soil from a soil spectrum obtained from reflected light reflected by the soil, in which a plurality of waveform groups approximating the waveform is generated from a set of waveforms of a soil spectrum obtained from a plurality of soils, a feature spectrum in each of the waveform groups is obtained, and the characteristics of the soil are analyzed by comparing the characteristic spectrum with a soil spectrum obtained from a soil having a new characteristic.

Furthermore, PTL 2 below discloses a spectroscopic measurement method for receiving light and measuring a spectrum representing light intensity at a first predetermined wavelength, the spectroscopic measurement method including: a spectroscopic step of dispersing the received light into light of a second predetermined wavelength that is a measurement wavelength; a measurement spectrum generation step of generating a measurement spectrum having the second number of light intensities by detecting light intensity at the second number of measurement wavelengths; a conversion matrix determination step of determining a conversion matrix for converting the measurement spectrum into the spectrum; and a measurement spectrum conversion step of converting the measurement spectrum into the spectrum by causing the conversion matrix to act on the measurement spectrum. The conversion matrix determination step includes a step of analyzing a principal component of the measurement spectrum obtained from a predetermined reference measuring instrument to select a third number of principal component vectors smaller than a second number of principal component vectors, a step of acquiring a known light measurement spectrum that is the measurement spectrum for known light of which the spectrum is known, a step of converting the known light measurement spectrum into a reference known light measurement spectrum by linearly projecting the known light measurement spectrum into a linear space constituted by the third number of principal component vectors, and a step of determining the conversion matrix on the basis of a condition that an evaluation function defined by linear combination of a deviation between an estimated spectrum that is the spectrum obtained by acting the conversion matrix on the reference known light measurement spectrum and the known light spectrum, and a variance of each component constituting the conversion matrix becomes an extreme value.

### CITATION LIST

### Patent Literature

PTL 1: JP 2006-038511A
PTL 2: JP 2014-038042A

### SUMMARY

### Technical Problem

Here, in a case where the compensation processing of the spectral sensitivity variation is performed on the output of the spectral sensor as in the above-described related method, the amount of information (the number of wavelengths) output from the spectral sensor is smaller than the amount of information (the number of wavelengths) of the spectral image to be finally obtained. From this point, it is difficult to obtain a spectral image with high accuracy in the spectral sensitivity variation compensation of the past described above.

The present technology has been made in view of the above problems, and it is desirable to improve accuracy of spectral sensitivity variation compensation of a spectral sensor and to improve spectral performance of a spectral camera.

### Solution to Problem

An information processing apparatus according to the present technology includes: a sensor input estimation unit that estimates a sensor input that is spectral information of input light to a spectral sensor on a basis of spectral reflectance information of a target subject and spectral information of a target light source; a sensor output estimation unit that estimates a sensor output that is spectral information output by the spectral sensor according to the sensor input on a basis of spectral sensitivity information of the spectral sensor and the sensor input; and a derivation processing unit that obtains an arithmetic algorithm that minimizes an error between a wavelength characteristic indicated by post-narrow-band spectral information obtained by performing narrowband processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor.

As described above, the arithmetic algorithm used in the narrow-band processing is obtained by the error minimization processing in which the wavelength characteristic of the sensor input is set as a target value, whereby the spectral sensitivity variation of the spectral sensor can be compensated if the light source and the subject are of the assumed object type by performing the narrow-band processing using the arithmetic algorithm. Then, since the arithmetic algorithm is derived so that the error between the post-narrow-band spectral information of the sensor output and the sensor input is minimized as described above, both the post-narrow-band spectral information of the sensor output and the sensor input can be the information of the wavelength resolution (resolution of Mch) after the narrow-band processing, and thus, it is possible to compensate for the spectral sensitivity variation with the accuracy of the number of wavelengths after the narrow-band processing.

Furthermore, an image processing apparatus according to the present technology uses an arithmetic algorithm obtained by an information processing apparatus, the information processing apparatus including a sensor input estimation unit that estimates a sensor input that is spectral information of input light to a spectral sensor on a basis of spectral reflectance information of a target subject and spectral information of a target light source; a sensor output estimation unit that estimates a sensor output that is spectral information output by the spectral sensor according to the sensor input on a basis of spectral sensitivity information of the spectral sensor and the sensor input; and a derivation processing unit that obtains an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor. The image processing apparatus includes: a spectral image generation unit that generates a narrow-band image with respect to a larger number of wavelengths than a number of output wavelengths of the spectral sensor by performing the narrow-band processing based on an output of the spectral sensor.

The arithmetic algorithm obtained by the information processing apparatus as described above is an arithmetic algorithm that can obtain spectral information in which a spectral sensitivity variation is compensated for as long as a light source and a subject are of an assumed subject type by performing narrow-band processing using the arithmetic algorithm.

### BRIEF DESCRIPTION OF DRAWINGS

FIG. 1 is a block diagram illustrating a schematic configuration example of a spectral camera as a target in an embodiment.

FIG. 2 is a diagram schematically illustrating a configuration example of a pixel array unit included in a spectral sensor.

FIG. 3 is an explanatory diagram of narrow-band processing according to the embodiment.

FIG. 4 is a diagram illustrating a configuration example of an algorithm derivation system including an information processing apparatus as an embodiment.

FIG. 5 is a diagram illustrating an example of subject spectral reflectance information.

FIG. 6 is a block diagram illustrating a schematic configuration example of an information processing apparatus as an embodiment.

FIG. 7 is a functional block diagram illustrating each of functions for algorithm derivation included in an information processing apparatus as an embodiment.

FIG. 8 is a block diagram illustrating a schematic configuration example of an image processing apparatus as an embodiment.

FIG. 9 is a diagram illustrating a configuration example of an algorithm derivation system as a second embodiment.

FIG. 10 is an explanatory diagram of an example of an algorithm derivation method in the second embodiment.

FIG. 11 is a diagram illustrating an example of a spectral image in which a plurality of subjects is captured.

FIG. 12 is a block diagram illustrating a schematic configuration example of a spectral camera as a first example of a third embodiment.

FIG. 13 is a block diagram illustrating a schematic configuration example of a spectral camera as a second example of the third embodiment.

FIG. 14 is a block diagram of a computer-based system on which embodiments of the present system may be implemented.

### DESCRIPTION OF EMBODIMENTS

Hereinafter, embodiments according to the present technology will be described in the following order with reference to the accompanying drawings.
<1. Spectral camera>
<2. First embodiment>
(2-1. System configuration)
(2-2. Configuration of information processing apparatus)
(2-3. Algorithm derivation method as embodiment)
(2-4. Image processing apparatus as embodiment)
<3. Second embodiment>
<4. Third EMBODIMENT>
(4-1. First example)
(4-2. Second example)
<5. Modification>
<6. Program>
<7. Notes>
<8. Summary of embodiments>
<9. Present technology>

### 1. SPECTRAL CAMERA

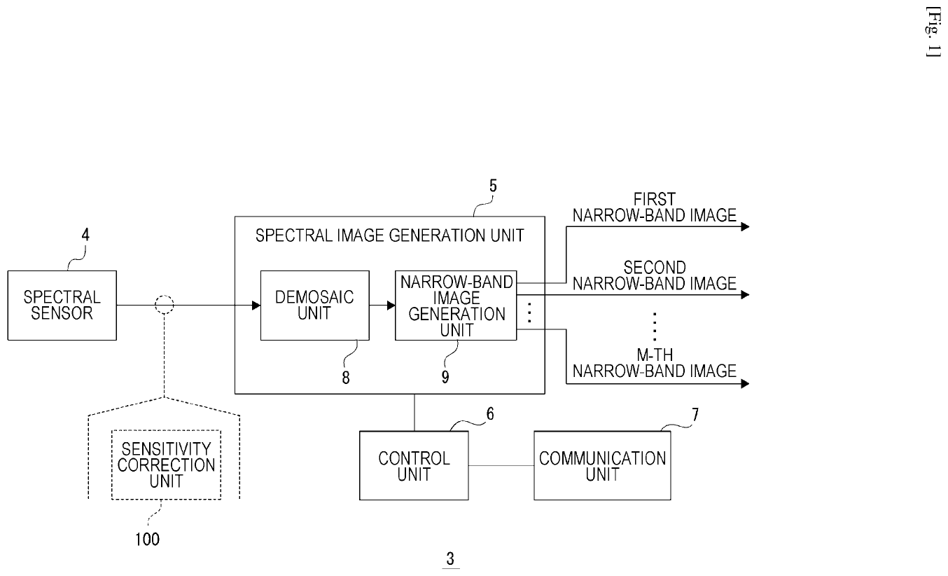

First, an example of a spectral camera targeted by the present technology will be described with reference to FIGS. 1 to 3.

FIG. 1 is a block diagram illustrating a schematic configuration example of a spectral camera 3 as a target in the embodiment.

Here, the “spectral camera” means a camera including a spectral sensor as a light receiving sensor. The “spectral sensor” is a light receiving sensor for obtaining a plurality of narrow-band images to be a wavelength characteristic analysis image for light from a subject.

As illustrated, the spectral camera 3 includes a spectral sensor 4, a spectral image generation unit 5, a control unit 6, and a communication unit 7.

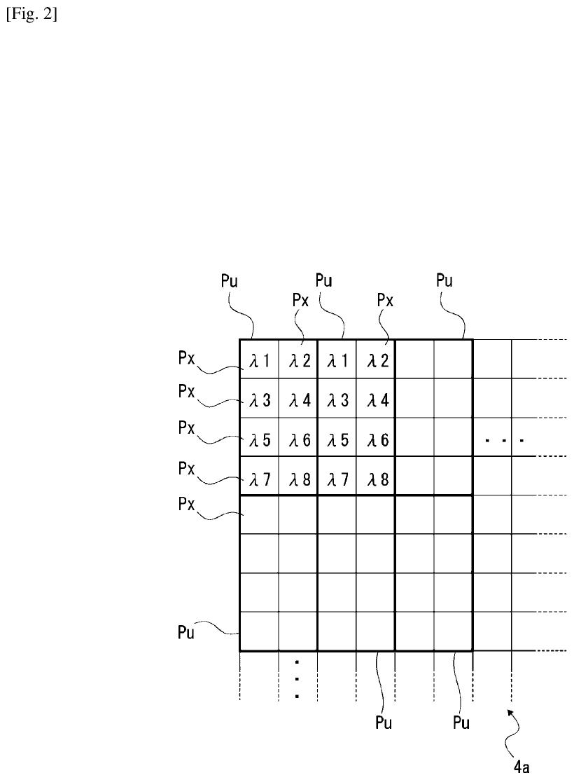

FIG. 2 is a diagram schematically illustrating a configuration example of a pixel array unit 4a included in the spectral sensor 4.

As illustrated, in the pixel array unit 4a, a spectral pixel unit Pu in which a plurality of pixels Px each receiving light of different wavelength bands is two-dimensionally arranged in a predetermined pattern is formed. The pixel array unit 4a includes a plurality of spectral pixel units Pu arranged two-dimensionally.

In the example of the drawing, an example in which each of the spectral pixel units Pu individually receives light of a total of eight wavelength bands of λ1 to λ8 in each of the pixels Px, in other words, an example in which the number of wavelength bands divided to be received in each of the spectral pixel units Pu (hereinafter, referred to as “number of light receiving wavelength channels”) is “8” is illustrated. However, this is merely an example for description, and the number of light receiving wavelength channels in the spectral pixel unit Pu may be at least a plurality, and can be arbitrarily set.

Hereinafter, the number of light receiving wavelength channels in the spectral pixel unit Pu is referred to as “N”.

In FIG. 1, the spectral image generation unit 5 generates M narrow-band images on the basis of a RAW image as an image output from the spectral sensor 4. Here, it is assumed that “M>N”, and for example, M=41 and the like with respect to N=8.

The spectral image generation unit 5 includes a demosaic unit 8 and a narrow-band image generation unit 9. The demosaic unit 8 performs demosaic processing on the RAW image from the spectral sensor 4, and the narrow-band image generation unit 9 performs narrow-band processing (linear matrix processing) based on each of the N-channel wavelength band images obtained by the demosaic processing, thereby generating M narrow-band images from the N wavelength band images.

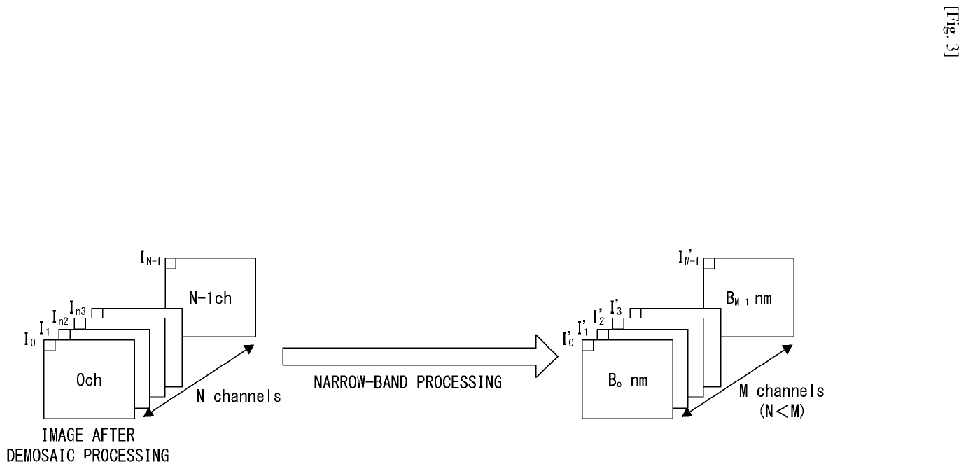

FIG. 3 is an explanatory diagram of the narrow-band processing for obtaining M narrow-band images.

On the basis of the wavelength band images for N channels obtained by the demosaic processing by the demosaic unit 8, matrix calculation is performed for each pixel position to obtain narrow-band images for M channels. In order to convert the wavelength band images for N channels into narrow-band images for M channels in this manner, processing of obtaining pixel values (in the drawing, I0 to IN−1) for M channels by matrix calculation using the pixel values (in the drawing, I′0 to I′M−1) for N channels for each pixel position is narrow-band processing.

Here, if a pixel value after demosaic processing is R, an input wavelength channel is n (0 to N−1), a narrow-band coefficient is C, an output pixel value by the narrow-band processing is B, and an output wavelength channel is m (0 to M−1), an arithmetic equation of the narrow-band processing can be expressed by the following [Equation 1].

$$\begin{matrix}[ Math . 1 ] & \\ B m = {\sum }_{n = 0}^{N - 1} ( R [ n ] * C m [ n ] ) & [ Equation 1 ]\end{matrix}$$

That is, a pixel value B0 of a 0th output wavelength channel (m=0)=R[0]×C0[0]+R[1]×C0[1]+R[2]×C0[2]+, . . . +R[N−1]×C0[N−1], and a pixel value B1 of a 1st output wavelength channel (m=1)=R[0]×C1[0]+R[1]×C1[1]+R[2]×C1[2]+, . . . +R[N−1]×C1[N−1].

Thereafter, similarly, a pixel value BM−1 of the last (M−1)th output wavelength channel (m=M−1)=R[0]×CM−1[0]+R[1]×CM−1[1]+R[2]×CM−1[2]+, . . . +R[N−1]×CM−1[N−1].

At this time, as a narrow-band coefficient C, a total of N×M of C0[0] to C0[N−1] for obtaining the pixel value B0, C1[0] to C1[N−1], . . . for obtaining the pixel value B1, and CM−1[0] to CM−1[N−1] for obtaining the pixel value BM−1 are used.

In FIG. 1, the control unit 6 includes a microcomputer including, for example, a central processing unit (CPU), a read only memory (ROM), a random access memory (RAM), and the like, and performs overall control of the spectral camera 3 by the CPU executing processing based on, for example, a program stored in the ROM or a program loaded in the RAM.

The communication unit 7 performs wired or wireless data communication with an external device. For example, the communication unit 7 may be configured to perform wired data communication with an external device according to a predetermined wired communication standard such as a universal serial bus (USB) communication standard, wireless data communication with an external device according to a predetermined wireless communication standard such as a Bluetooth (registered trademark) communication standard, or wireless or wired data communication with an external device via a predetermined network such as the Internet.

The control unit 6 can transmit and receive data to and from an external device via the communication unit 7.

### 2. First Embodiment

### (2-1. System Configuration)

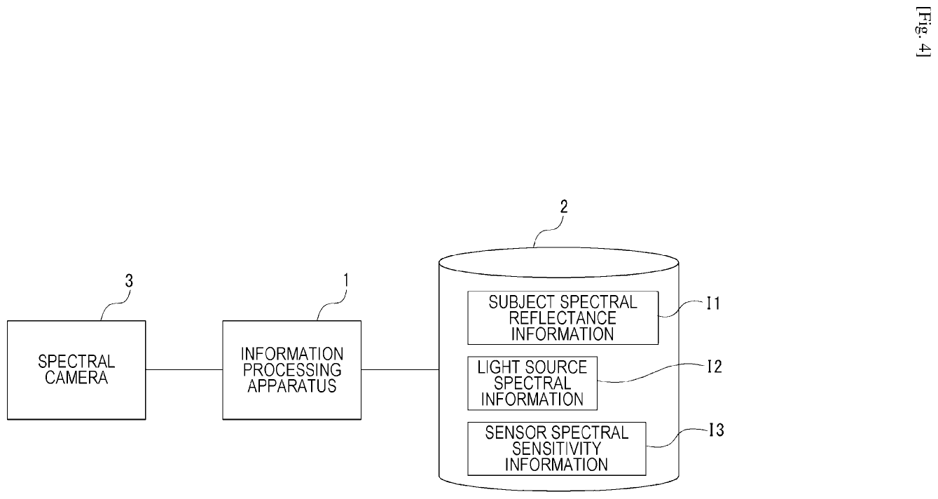

FIG. 4 is a diagram illustrating a configuration example of an algorithm derivation system including an information processing apparatus 1 as an embodiment of the information processing apparatus according to the present technology.

As illustrated, the algorithm derivation system as an embodiment includes an information processing apparatus 1, a database 2, and a spectral camera 3.

The information processing apparatus 1 is configured as a computer device, and performs a process of deriving an arithmetic algorithm (for example, the above-described narrow-band coefficient C) of narrow-band processing for the spectral sensitivity variation of the spectral sensor 4 in the spectral camera 3 as described later.

The information processing apparatus 1 in the present example derives an arithmetic algorithm for compensating for the spectral sensitivity variation of the spectral sensor 4 on the basis of subject spectral reflectance information I1, light source spectral information 12, and sensor spectral sensitivity information I3 stored in the storage device as the database 2.

Here, the subject spectral reflectance information I1 is information indicating the spectral reflectance of the subject, that is, the reflectance for each wavelength. Furthermore, the light source spectral information I2 is spectral information of the light source, that is, information indicating light intensity for each wavelength.

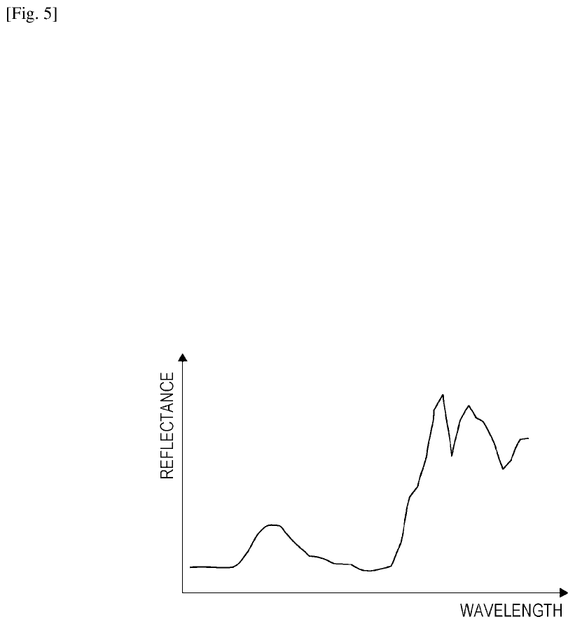

FIG. 5 illustrates an example of the subject spectral reflectance information I1. In the present embodiment, spectral reflectance information of a subject selected in advance as a target is stored as the subject spectral reflectance information I1.

In the database 2 of FIG. 4, the sensor spectral sensitivity information I3 is information indicating the sensitivity of the spectral sensor 4 for each wavelength. As the sensor spectral sensitivity information I3, for example, a sensor obtained by measuring the spectral sensor 4 in advance using a dedicated measurement device or the like is stored in the database 2.

Here, the spectral sensitivity of the spectral sensor 4 can be different for each individual spectral sensor 4. Therefore, in the case of deriving an arithmetic algorithm suitable for each of the plurality of spectral cameras 3, the sensor spectral sensitivity information I3 measured for each spectral sensor 4 included in each of the spectral cameras 3 is stored in the database 2, and the spectral sensitivity information measured for the spectral sensor 4 included in the target spectral camera 3 is used in the derivation processing of the arithmetic algorithm as described later.

The information processing apparatus 1 in the present example also performs processing for setting the derived arithmetic algorithm in the spectral camera 3. Specifically, the information processing apparatus 1 in the present example performs processing of transmitting the narrow-band coefficient C derived by a derivation method as described later to the spectral camera 3 as the narrow-band coefficient C used in the narrow-band processing of the narrow-band image generation unit 9.

Note that it is not essential for the information processing apparatus 1 itself to transmit the information of the arithmetic algorithm derived by the information processing apparatus 1 to the spectral camera 3. For example, it is conceivable that information of an arithmetic algorithm derived by the information processing apparatus 1 is stored on a cloud, and the spectral camera 3 acquires the information of the arithmetic algorithm from the cloud.

### (2-2. Configuration of Information Processing Apparatus)

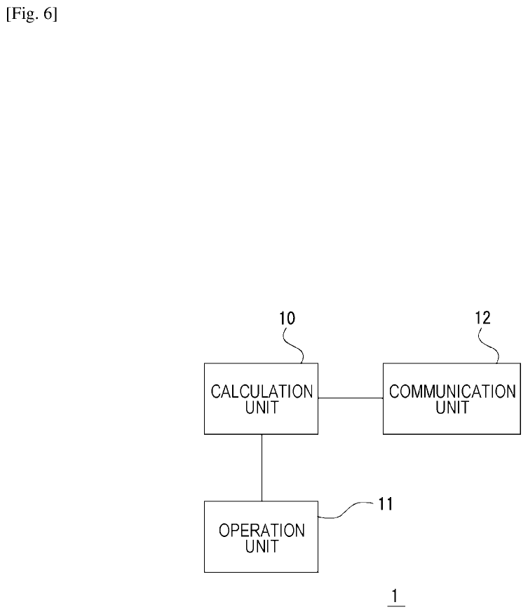

FIG. 6 is a block diagram illustrating a schematic configuration example of the information processing apparatus 1.

As illustrated, the information processing apparatus 1 includes a calculation unit 10, an operation unit 11, and a communication unit 12.

The calculation unit 10 includes, for example, a microcomputer including a CPU, a ROM, a RAM, and the like, and performs predetermined calculation and overall control of the information processing apparatus 1 by the CPU executing a process based on a program stored in the ROM or a program loaded in the RAM.

The operation unit 11 includes various operators such as a keyboard, a mouse, a key, a dial, a touch panel, and a touch pad for the user to input an operation to the information processing apparatus 1, and outputs an operation signal corresponding to an operation on the operators to the calculation unit 10.

The calculation unit 10 executes processing according to the operation signal. Therefore, the processing of the information processing apparatus 1 according to the user operation is realized.

The communication unit 12 performs wired or wireless data communication with an external device (particularly, the database 2 or the spectral camera 3 illustrated in FIG. 4 in this example). Similarly to the communication unit 7 described above, the communication unit 12 may be configured to perform wired data communication with an external device according to a predetermined wired communication standard such as a USB communication standard, wireless data communication with an external device according to a predetermined wireless communication standard such as a Bluetooth communication standard, or wireless or wired data communication with an external device via a predetermined network such as the Internet.

The calculation unit 10 can transmit and receive data to and from an external device via the communication unit 12.

### (2-3. Algorithm Derivation Method as Embodiment)

Here, as described above, in the past, in order to compensate for the spectral sensitivity variation of the spectral sensor 4, compensation processing of the spectral sensitivity variation is performed on the output of the spectral sensor 4 (see the sensitivity correction unit 100 indicated by a dotted line in FIG. 1).

However, the amount of information (the number of wavelengths) output from the spectral sensor 4 is smaller than the amount of information (the number of wavelengths) of the spectral image to be finally obtained by the narrow-band processing, and it is difficult to obtain the spectral image with high accuracy by the spectral sensitivity variation compensation of the past as described above.

Here, in the related method, the spectral sensitivity variation is appropriately compensated according to any combination of the subject and the light source regardless of the types of the subject and the light source.

On the other hand, an embodiment of the present embodiment is not to be able to cope with any combination of a subject and a light source as in the related method, but to perform spectral sensitivity variation compensation suitable for a combination of a target subject and a light source by partially narrowing the combination of the subject and the light source.

Then, instead of performing the compensation processing of the spectral sensitivity variation on the output of the spectral sensor 4 as in the related art, a method is adopted in which a function of spectral sensitivity variation compensation is included in the narrow-band processing.

Specifically, in the present embodiment, for the target subject and the target light source as the subject and the light source partially narrowed as described above, the post-narrow-band spectral information obtained by the narrow-band processing is obtained by simulation using the spectral reflectance information of the target subject and the spectral information of the target light source. At this time, in order to compensate for the spectral sensitivity variation of the spectral sensor 4 by the narrowband processing, an arithmetic algorithm capable of reproducing the wavelength characteristic of the input spectroscopic (“sensor input” as described later) with respect to the spectral sensor 4 is only required to be derived as the arithmetic algorithm of the narrow-band processing. Therefore, in the present embodiment, a method of deriving an arithmetic algorithm capable of minimizing an error between the wavelength characteristic indicated by the post-narrow-band spectral information obtained by the above-described simulation and the wavelength characteristic of the input spectroscopic with respect to the spectral sensor 4 is adopted.

In the present example, since it is assumed that the narrow-band processing is performed by the matrix calculation according to [Equation 1] described above, the narrow-band coefficient C is derived as the above-described arithmetic algorithm.

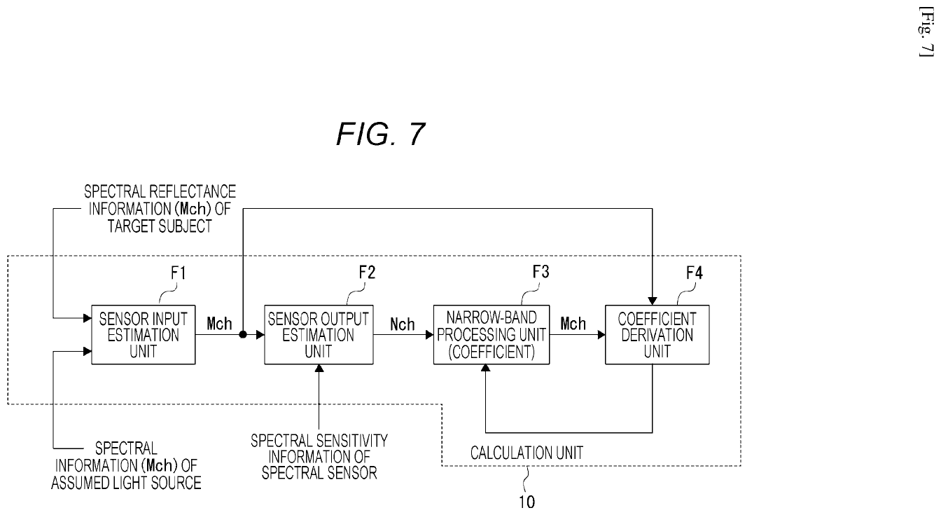

A specific example of an algorithm derivation method as an embodiment will be described with reference to FIG. 7.

FIG. 7 is a functional block diagram illustrating each function for algorithm derivation included in the calculation unit 10 in the information processing apparatus 1.

As illustrated, the calculation unit 10 includes a sensor input estimation unit F1, a sensor output estimation unit F2, a narrow-band processing unit F3, and a coefficient derivation unit F4 as functional units for deriving coefficients.

Here, the sensor input estimation unit F1 and the sensor output estimation unit F2 are examples of a “sensor input estimation unit” and a “sensor output estimation unit” according to the present technology, respectively, and the narrow-band processing unit F3 and the coefficient derivation unit F4 are examples of a “derivation processing unit” according to the present technology.

The sensor input estimation unit F1 estimates a sensor input, which is spectral information of input light to the spectral sensor 4, on the basis of the spectral reflectance information of the target subject and spectral information of the target light source.

Here, in this example, in order to avoid complication of description, it is assumed that there is only one target subject and one target light source. Here, as an application for performing subject analysis on the basis of the narrow-band image obtained by the spectral camera 3, for example, “lettuce”, “tomato (leaves of tomato)”, or the like can be exemplified in a case where an application for analyzing vegetation of plants such as vegetables is assumed, and it is conceivable that the target subject is “human skin” in a case where an application for performing human skin condition analysis is assumed.

Furthermore, examples of the target light source include “sun” and various “lighting devices”, for example, a fluorescent lamp, a white bulb, and a light emitting diode (LED).

As illustrated in the drawing, information based on the wavelength resolution of Mch (that is, information indicating the reflectance and the light intensity for each of the M wavelength channels) is used for the spectral reflectance information of the target subject and the spectral information of the target light source.

The spectral reflectance information of the target subject and the spectral information of the target light source are stored as the subject spectral reflectance information I1 and the light source spectral information I2 in the database 2 illustrated in FIG. 4, respectively.

The sensor input estimation unit F1 acquires the spectral reflectance information of the target subject and the spectral information of the target light source stored as the subject spectral reflectance information I1 and the light source spectral information I2 in the database 2, and estimates the sensor input on the basis of the spectral reflectance information of the target subject and the spectral information of the target light source. For example, the sensor input is obtained by multiplying the light intensity for each wavelength channel indicated by the spectral information of the target light source by the reflectance of the corresponding wavelength channel indicated by the spectral reflectance information of the target subject.

Therefore, the sensor input in the present example is obtained as information indicating the light intensity of each of the M wavelength channels for the input light to the spectral sensor 4.

On the basis of the spectral sensitivity information and the sensor input of the spectral sensor 4, the sensor output estimation unit F2 estimates a sensor output that is spectral information output from the spectral sensor 4 according to the sensor input.

Specifically, the sensor output estimation unit F2 acquires the spectral sensitivity information of the spectral sensor 4 stored in the database 2 as the sensor spectral sensitivity information I3, and estimates the sensor output (Nch) on the basis of the acquired spectral sensitivity information and the sensor input estimated by the sensor input estimation unit F1.

Here, the estimation of the sensor output involves wavelength conversion processing for reducing the number of wavelengths from M to N, contrary to the narrow-band processing. In this wavelength conversion processing, an arithmetic equation for wavelength conversion as in the above [Equation 1] is used. In this case, the spectral sensitivity information of the spectral sensor 4 obtained as information of a coefficient (a coefficient corresponding to the narrow-band coefficient C in the arithmetic equation of the narrow-band processing) in the arithmetic equation for the wavelength conversion is stored in the database 2 as the sensor spectral sensitivity information I3, and the sensor output estimation unit F2 obtains the sensor output of Nch by performing the wavelength conversion processing on the sensor input by the Mch-to-Nch wavelength conversion arithmetic equation in which the coefficient is set.

The narrow-band processing unit F3 performs the narrow-band processing for estimating spectral information for a larger number of wavelengths than the number of wavelengths of the sensor output on the basis of the sensor output. Specifically, the narrow-band processing is performed on the sensor output estimated by the sensor output estimation unit F2 by the arithmetic equation of [Equation 1] described above, thereby obtaining the post-narrow-band spectral information corresponding to Mch.

The coefficient derivation unit F4 obtains the narrow-band coefficient C so as to minimize the error D between the wavelength characteristic indicated by the post-narrow-band spectral information obtained by the narrow-band processing unit F3 and the wavelength characteristic indicated by the sensor input. Since both the post-narrow-band spectral information and the sensor input are information indicating the light intensity for each wavelength as “spectral information”, the error D is calculated as information indicating an error in the light intensity for each wavelength.

Here, various methods can be considered as a derivation processing method of the narrow-band coefficient C in the coefficient derivation unit F4. For example, a method is conceivable in which, under a condition that a plurality of sets of narrow-band coefficients C as candidates is prepared, the narrow-band processing unit F3 is caused to execute the narrow-band processing while sequentially changing the set of narrowband coefficients C set in the narrow-band processing unit F3, an error D is obtained for each set of narrow-band coefficients C, and the set of narrow-band coefficients C having the minimum error D is determined as the set of narrow-band coefficients C that compensates for spectral sensitivity variations.

Alternatively, it is also conceivable that the derivation processing of the narrow-band coefficient C is performed as processing using a least squares method, for example, processing using a regression analysis algorithm such as Ridge regression or Lasso regression.

Furthermore, it is also conceivable to derive an arithmetic algorithm of the narrowband processing having the compensation function of the spectral sensitivity variation using a technique of artificial intelligence (AI). Specifically, an AI model that performs narrow-band processing having the compensation function of the spectral sensitivity variation is generated by machine learning.

In this case, in the machine learning of the AI model, the learning input data is set as a sensor output when the spectral sensor 4 senses the target subject in a state irradiated with light from the target light source, and the training data is set as a sensor input. By performing such machine learning, it is possible to form an arithmetic algorithm that minimizes an error between the wavelength characteristic indicated by the post-narrow-band spectral information obtained by performing the narrow-band processing based on the sensor output and the wavelength characteristic indicated by the sensor input in the AI model. That is, it is possible to derive an arithmetic algorithm of the narrow-band processing capable of compensating for the spectral sensitivity variation of the spectral sensor 4.

According to the algorithm derivation method as the embodiment as described above, since the derivation processing of the arithmetic algorithm of the narrow-band processing is performed with the wavelength characteristic of the sensor input as a target value, the spectral information in which the spectral sensitivity variation of the spectral sensor 4 is compensated can be obtained as the post-narrow-band spectral information if the light source and the subject are of the assumed object type by the spectral camera 3 performing the narrow-band processing using the arithmetic algorithm derived as described above.

Then, since the arithmetic algorithm is derived so that the error between the post-narrow-band spectral information of the sensor output and the sensor input is minimized as described above, both the post-narrow-band spectral information of the sensor output and the sensor input can be the information of the wavelength resolution (resolution of Mch) after the narrow-band processing, and thus, it is possible to compensate for the spectral sensitivity variation with the accuracy of the number of wavelengths after the narrow-band processing.

Therefore, accuracy of spectral sensitivity variation compensation of the spectral sensor can be improved, and spectral performance of the spectral camera can be improved.

Here, in the above description, an example in which only one type of subject and one type of light source are assumed as the target subject and the target light source has been described, but a plurality of target subjects and target light sources can also be assumed.

For example, in a case where a plurality of subjects is assumed only on the target subject side, that is, in a case where the spectral sensitivity variation compensation is appropriately performed only for the plurality of types of assumed subjects, the narrow-band coefficient C is only required to be derived as follows.

That is, the sensor input estimation unit F1 estimates the sensor input for each target subject on the basis of the spectral reflectance information of the plurality of target subjects and the spectral information of the target light source, the sensor output estimation unit F2 estimates the sensor output for each target subject on the basis of the sensor input for each target subject, and the narrow-band processing unit F3 estimates the post-narrow-band spectral information for each target subject on the basis of the sensor output for each target subject. Further, it goes without saying that the spectral reflectance information of the target spectral sensor 4 is used in the estimation of the sensor output in the sensor output estimation unit F2.

Then, the coefficient derivation unit F4 calculates the error D for each target subject on the basis of the post-narrow-band spectral information for each target subject estimated by the narrow-band processing unit F3 and the sensor input, and obtains a set of narrow-band coefficients C on the basis of the calculated error D for each target subject.

In this case, it is conceivable that the coefficient derivation unit F4 uses, as an evaluation index value, an integrated value of the errors D for each target subject, such as a total value or an average value of the errors D for each target subject, for example, and obtains a set of narrow-band coefficients C so as to minimize the evaluation index value.

Alternatively, in a case where there is a target subject to be prioritized among a plurality of assumed target subjects, it is also conceivable to obtain a set of narrowband coefficients C so that the error D of the target subject to be prioritized is preferentially reduced.

Furthermore, in a case where a plurality of types is assumed only on the target light source side, that is, in a case where the spectral sensitivity variation compensation is appropriately performed only for the plurality of types of assumed light sources, the narrow-band coefficient C is only required to be derived as follows.

That is, the sensor input estimation unit F1 estimates the sensor input for each target light source on the basis of the spectral reflectance information of the target subject and the spectral information of the plurality of target light sources, the sensor output estimation unit F2 estimates the sensor output for each target light source on the basis of the sensor input for each target light source, and the narrow-band processing unit F3 estimates the post-narrow-band spectral information for each target light source on the basis of the sensor output for each target light source.

Then, the coefficient derivation unit F4 calculates the error D for each target light source on the basis of the post-narrow-band spectral information for each target light source estimated by the narrow-band processing unit F3 and the sensor input, and obtains a set of narrow-band coefficients C on the basis of the calculated error D for each target light source.

In this case, the coefficient derivation unit F4 uses, as an evaluation index value, an integrated value of the errors D for each target light source, such as a total value or an average value of the errors D for each target light source, for example, and obtains a set of narrow-band coefficients C such that the evaluation index value is minimized.

Alternatively, in a case where there is a target light source to be prioritized among a plurality of assumed target light sources, it is also conceivable to obtain a set of narrow-band coefficients C so that the error D of the target light source to be prioritized is preferentially reduced.

Moreover, it is also conceivable to assume a plurality of both the target subjects and the target light sources, that is, to appropriately perform the spectral sensitivity variation compensation only for each combination of a plurality of types of assumed subjects and light sources.

In that case, the sensor input estimation unit F1 estimates the sensor input for each combination of the target subject and the target light source on the basis of the spectral reflectance information of the plurality of target subjects and the spectral information of the plurality of target light sources, the sensor output estimation unit F2 estimates the sensor output for each combination on the basis of the sensor input for each combination, and the narrow-band processing unit F3 estimates the post-narrow-band spectral information for each combination on the basis of the sensor output for each combination.

Then, the coefficient derivation unit F4 calculates the error D for each combination on the basis of the post-narrow-band spectral information for each combination estimated by the narrow-band processing unit F3 and the sensor input, and obtains a set of narrow-band coefficients C on the basis of the calculated error D for each combination. In this case, the coefficient derivation unit F4 uses, as an evaluation index value, an integrated value of the errors D for each combination, such as a total value or an average value of the errors D for each combination, for example, and obtains a set of narrow-band coefficients C so as to minimize the evaluation index value.

Alternatively, in a case where there is a combination to be prioritized among a plurality of assumed combinations of the target subjects and the target light sources, it is also conceivable to obtain a set of narrow-band coefficients C so that the error D of the combination to be prioritized becomes smaller.

### (2-4. Image Processing Apparatus as Embodiment)

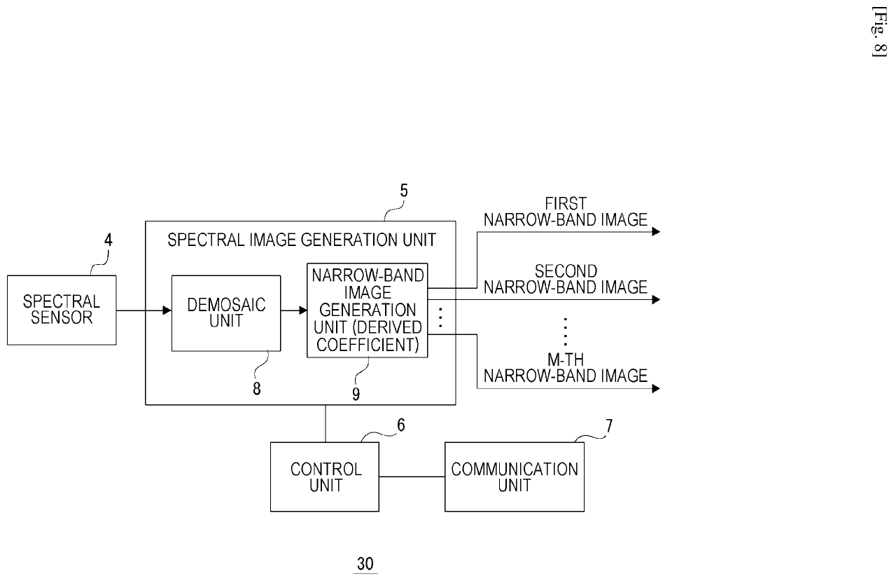

FIG. 8 is a block diagram illustrating a schematic configuration example of a spectral camera 30 which is an embodiment of an image processing apparatus according to the present technology.

Note that, in the following description, the same reference numerals are given to portions similar to those already described, and description thereof will be omitted.

The spectral camera 30 of the embodiment is similar to the spectral camera 3 illustrated in FIG. 1 in that the spectral sensor 4, the spectral image generation unit 5, the control unit 6, and the communication unit 7 are included, but is different from the spectral camera 3 in that, in the narrow-band image generation unit 9, the arithmetic algorithm of the narrow-band processing obtained by the information processing apparatus 1 according to the algorithm derivation method as the embodiment described above, specifically, the narrow-band coefficient C is set in the narrow-band image generation unit 9.

That is, it can be said that the spectral camera 30 as the embodiment includes the following spectral image generation unit 5. That is, the information processing apparatus 1 includes the spectral image generation unit 5 that performs the narrowband processing based on the output of the spectral sensor 4 using the arithmetic algorithm obtained by the algorithm derivation method as the embodiment to generate narrow-band images for a larger number of wavelengths than the number of output wavelengths of the spectral sensor.

As understood from the above description, the arithmetic algorithm of the narrowband processing obtained by the information processing apparatus 1 according to the algorithm derivation method as the embodiment is an arithmetic algorithm that can obtain the post-narrow-band spectral information in which the spectral sensitivity variation of the spectral sensor 4 is compensated for by performing the narrow-band processing using the arithmetic algorithm when the light source and the subject are of the assumed object type.

Therefore, according to the spectral camera 30 as the embodiment that performs the narrow-band processing using such an arithmetic algorithm, it is possible to improve the accuracy of spectral sensitivity variation compensation.

Note that, in the case of using the AI model, the spectral image generation unit 5 is configured to perform the narrow-band processing using the AI model derived by the algorithm derivation method as the embodiment.

### 3. SECOND EMBODIMENT

Next, a second embodiment will be described.

The second embodiment relates to a method for reducing a user operation burden related to algorithm derivation in a case where a target subject and a target light source are determined for each application for an application that performs subject analysis based on a spectral image obtained by the spectral camera 30.

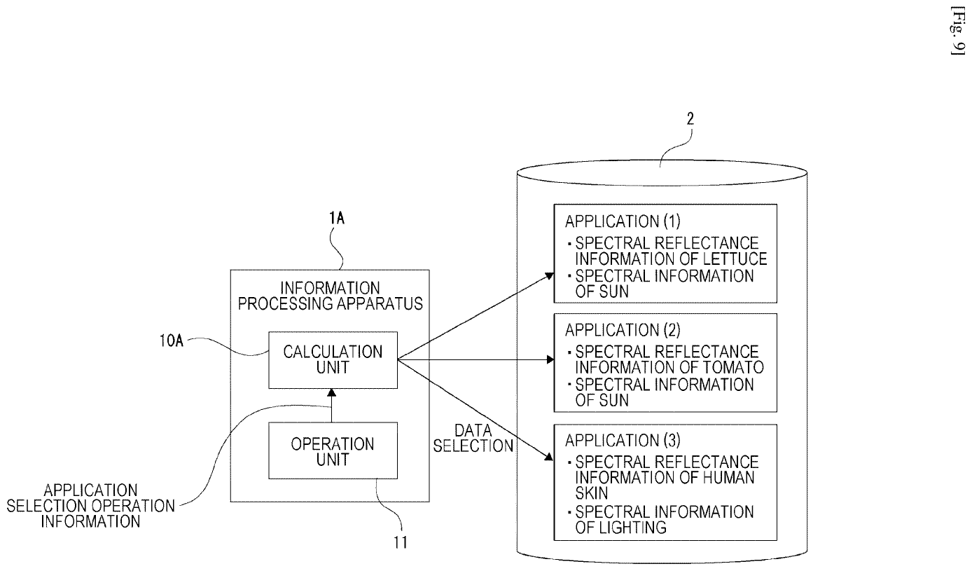

FIG. 9 is a diagram illustrating a configuration example of an algorithm derivation system as the second embodiment.

As illustrated, in the algorithm derivation system as the second embodiment, an information processing apparatus 1A is provided instead of the information processing apparatus 1.

Although FIG. 9 illustrates a schematic configuration example of the information processing apparatus 1A, the information processing apparatus 1A includes a calculation unit 10A instead of the calculation unit 10. Note that the information processing apparatus 1A also includes a communication unit 12 similarly to the information processing apparatus 1, but is not illustrated here.

Furthermore, in the algorithm derivation system of the second embodiment, the database 2 stores a set of spectral reflectance information of the target subject and spectral information of the target light source for each application. Note that, in the algorithm derivation method of the embodiment, the spectral sensitivity information I3 is also necessary for deriving the arithmetic algorithm of the narrow-band processing, but is not illustrated here.

In the algorithm derivation system according to the second embodiment, the user operates the information processing apparatus 1A to select an application from which an arithmetic algorithm of the narrow-band processing is to be derived.

According to the selection operation, operation information (hereinafter referred to as “application selection operation information”) indicating the selection operation is input from the operation unit 11 to the calculation unit 10A.

The calculation unit 10A selects a set of spectral reflectance information of a target subject and spectral information of a target light source stored for an application selected by the user from the database 2 on the basis of the application selection operation information, and uses the spectral reflectance information of the selected target subject and the spectral information of the target light source for a process of obtaining an arithmetic algorithm of the narrow-band processing. That is, it is used for the process of obtaining the arithmetic algorithm by the algorithm derivation method as the embodiment described above.

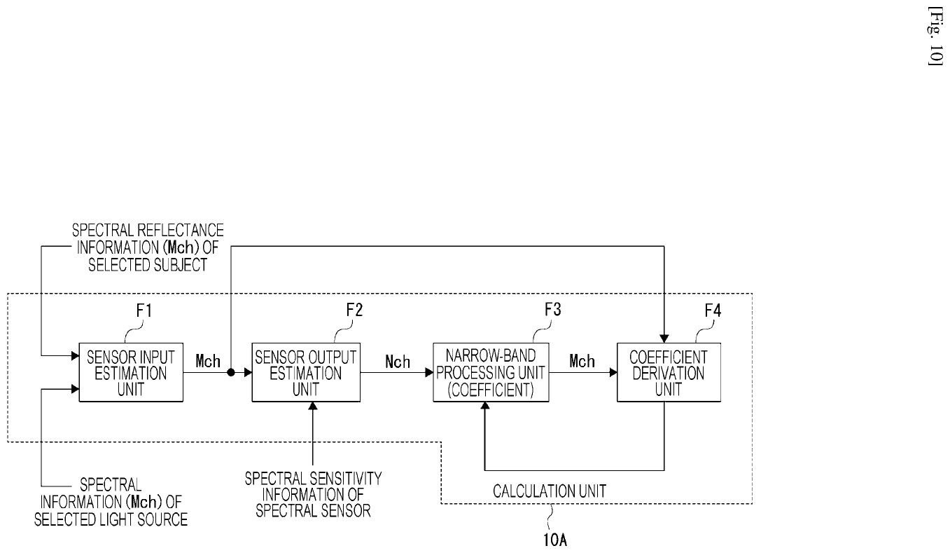

Specifically, in the case of deriving the narrow-band coefficient C, as exemplified in FIG. 10, processing as the sensor input estimation unit F1 is performed using the spectral reflectance information of the selected subject and the spectral information of the selected light source. Note that the processing after the sensor output estimation unit F2 is similar to that of the first embodiment, and thus redundant description is avoided.

According to the information processing apparatus 1A as the second embodiment as described above, in deriving the arithmetic algorithm suitable for the application, it is not necessary for the user to specify the combination of the target subject and the target light source, and it is sufficient to perform only the selection operation of the application.

Therefore, it is possible to reduce the operation burden on the user in deriving the arithmetic algorithm suitable for the application.

Further, in the second embodiment, a plurality of target subjects and target light sources may be assumed for each application. Alternatively, it is also conceivable to assume a plurality of only target subjects or target light sources for each application.

Note that, since the derivation method of the arithmetic algorithm in a case where a plurality of target subjects and target light sources is assumed has already been described, redundant description is avoided.

### 4. THIRD EMBODIMENT

A third embodiment relates to a subject determination method in a spectral camera, and specifically relates to a method of determining a subject appearing in a spectral image on the basis of spectral information.

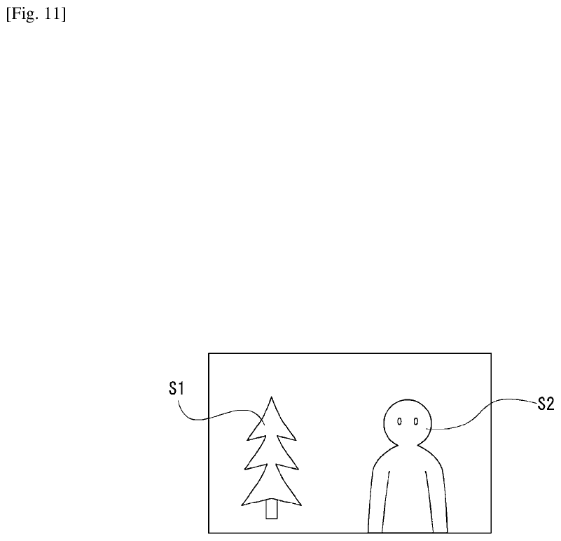

FIG. 11 illustrates an example of a spectral image in which a plurality of subjects S is captured.

Specifically, here, an example is illustrated in which a subject S1 as a tree and a subject S2 as a person are included in a spectral image.

In the third embodiment, a method is adopted in which similarity between an actually measured wavelength characteristic based on the output of the spectral sensor 4 and a wavelength characteristic of a target subject is evaluated for each unit area of a spectral image obtained by demosaic processing the output of the spectral sensor 4, and whether or not the subject is the target subject is determined for each unit area on the basis of an evaluation result of the similarity. Here, the actually measured wavelength characteristic means a wavelength characteristic of spectral information obtained on the basis of the output of the spectral sensor 4. Furthermore, the unit area means a divided area when the spectral image is divided in units of a predetermined number of pixels. Note that the number of pixels of the unit area can be arbitrarily set, but here, as an example, it is assumed that the unit area=one pixel.

For example, in a case where it is assumed that a plurality of subjects S1 and S2 is included as exemplified in FIG. 11, at least one of similarity evaluation between the actually measured wavelength characteristic and the wavelength characteristic of the subject S1 and similarity evaluation between the actually measured wavelength characteristic and the wavelength characteristic of the subject S2 is performed for each unit area, and it is determined whether or not the subject S is the subject S1 or S2 for each unit area. Here, as an example in which the plurality of subjects S is included in the spectral image, for example, it can be assumed that all areas other than the area of the subject S1 are the area of the subject S2, and in this case, it is not necessary to perform similarity evaluation based on the wavelength characteristic of the subject S2 for the unit area determined to be the area of the subject S1 in the similarity evaluation based on the wavelength characteristic of the subject S1. Furthermore, even if it is assumed that subject areas other than the subject S1 and the subject S2 exist in the spectral image as in the example of FIG. 11, it is not necessary to perform the similarity evaluation based on the wavelength characteristic of the subject S2 for the unit area determined to be the area of the subject S1 in the similarity evaluation based on the wavelength characteristic of the subject S1.

In this sense, the subject determination for each unit area may be made by performing at least one of similarity evaluation based on the wavelength characteristic of the subject S1 and similarity evaluation based on the wavelength characteristic of the subject S2.

Then, in the third embodiment, as a result of the subject determination as described above, algorithm switching processing of switching the arithmetic algorithm is performed such that the arithmetic algorithm obtained corresponding to the subject S1 is used in the narrow-band processing for the unit area in which the subject is determined to be the subject S1, and the arithmetic algorithm obtained corresponding to the subject S2 is used in the narrow-band processing for the unit area in which the subject is determined to be the subject S2.

The spectral camera (spectral cameras 30B and 30C described below) of the third embodiment performs subject determination and algorithm switching processing as described above, but the spectral camera in this case can be expressed as including a subject determination unit and a switching processing unit as described below.

That is, the image processing apparatus includes: a subject determination unit that performs at least one of a first process of evaluating similarity between an actually measured wavelength characteristic and a wavelength characteristic of a first subject and a second process of evaluating similarity between an actually measured wavelength characteristic and a wavelength characteristic of a second subject for each unit area of a spectral image and determines whether or not a subject is a first subject or a second subject for each unit area; and a switching processing unit that performs switching of an arithmetic algorithm used in the narrow-band processing such that the arithmetic algorithm obtained for the first subject in the narrow-band processing for the unit area for which the subject is determined to be the first subject by the subject determination unit is used and the arithmetic algorithm obtained for the second subject in the narrow-band processing for the unit area for which the subject is determined to be the second subject by the subject determination unit is used.

Here, in the third embodiment, in order to enable the algorithm switching processing as described above, the spectral camera stores an arithmetic algorithm derived by an algorithm derivation method as an embodiment with the first subject as a target subject and an arithmetic algorithm derived by an algorithm derivation method as an embodiment with the second subject as a target subject.

That is, in the third embodiment, it is assumed that the information processing apparatus 1 performs algorithm derivation as an embodiment in which the first subject is set as the target subject and algorithm derivation as an embodiment in which the second subject is set as the target subject in advance to derive the respective arithmetic algorithms for the first subject and the second subject.

As described above, in the third embodiment, the method of determining whether or not the subject is the target subject on the basis of the similarity evaluation result between the actually measured wavelength characteristic based on the output of the spectral sensor 4 and the wavelength characteristic of the target subject is adopted. However, this eliminates the need to perform complicated image analysis processing such as subject recognition processing using the AI model and rule-based subject recognition processing by template matching of the subject or the like on the basis of the captured image of the image sensor provided separately from the spectral sensor, and the subject recognition processing for the previously assumed target subject can be realized with simple processing.

Furthermore, in the third embodiment, by performing the algorithm switching processing as described above, in a case where different subjects are captured within the angle of view, it is possible to perform the narrow-band processing with an arithmetic algorithm suitable for each subject.

Therefore, spectral information can be obtained with high accuracy for each subject. Here, in a case where different subjects are captured within the angle of view, it is naturally conceivable that the user performs a designation operation of a region in which each subject appears in the image and a designation operation of an arithmetic algorithm used in each region.

By performing the subject determination and algorithm switching processing as described above, it is not necessary to impose such an operation burden on the user, and it is possible to reduce the user operation burden in order to obtain spectral information with high accuracy for each subject.

Note that it is also conceivable that the recognition information of the subject (information indicating each subject area in the image) obtained as a result of the subject determination processing as described above is used on the application side as the segmentation information of the subject.

Here, the subject determination for each unit area is considered to be performed at a stage (stage of Nch) after the demosaic processing by the demosaic unit 8 and at a stage (stage of Mch) after the narrow-band processing.

Hereinafter, the former case will be described as a first example, and the latter case will be described as a second example.

### (4-1. First Example)

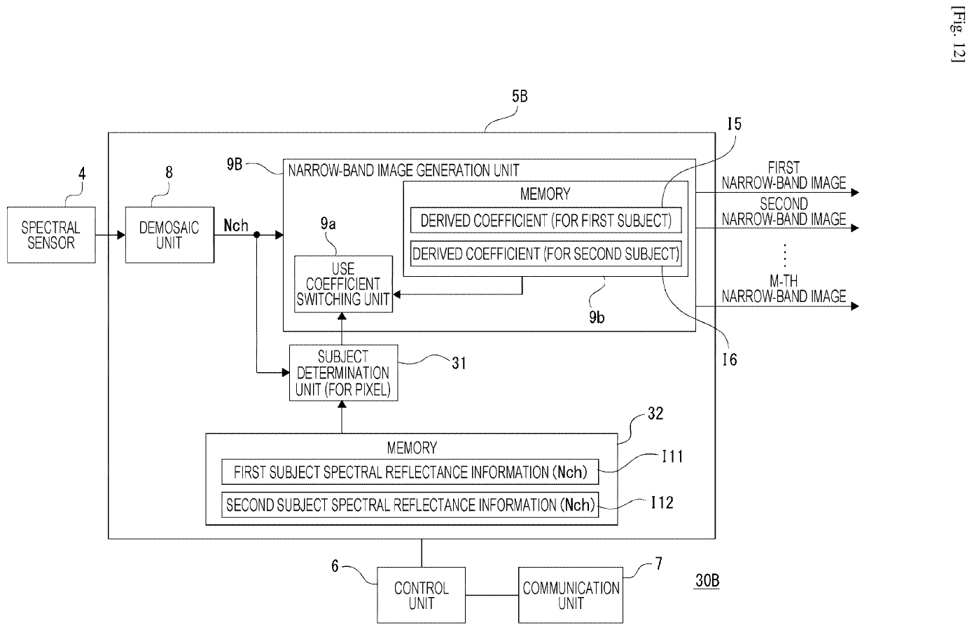

FIG. 12 is a block diagram illustrating a schematic configuration example of a spectral camera 30B as the first example of the third embodiment.

The spectral camera 30B is different from the spectral camera 30 illustrated in FIG. 8 in that a spectral image generation unit 5B is provided instead of the spectral image generation unit 5.

The spectral image generation unit 5B is different from the spectral image generation unit 5 in that a narrow-band image generation unit 9B is provided instead of the narrow-band image generation unit 9 and that a subject determination unit 31 and a memory 32 are provided.

As illustrated, the memory 32 stores first subject spectral reflectance information I11 that is spectral reflectance information of the first subject and second subject spectral reflectance information I12 that is spectral reflectance information of the second subject.

In the first example, since the subject determination is performed on the actually measured wavelength characteristic of Nch after the demosaic processing, reflectance information based on the wavelength resolution of Nch is stored as the first subject spectral reflectance information I11 and the second subject spectral reflectance information I12.

The narrow-band image generation unit 9B includes a use coefficient switching unit 9a and a memory 9b.

The memory 9b stores a derived coefficient I5 and a derived coefficient I6. The derived coefficient I5 is a narrow-band coefficient C obtained by the information processing apparatus 1 using an algorithm derivation method as an embodiment in which the first subject is a target subject, and the derived coefficient I6 is a narrowband coefficient C obtained by the information processing apparatus 1 using an algorithm derivation method as an embodiment in which the second subject is a target subject.

In the spectral camera 30B, the subject determination unit 31 performs subject determination on the spectral images of Nch obtained by the demosaic unit 8 based on the first subject spectral reflectance information I11 and the second subject spectral reflectance information I12 stored in the memory 32 for each pixel (for each unit area). Specifically, at least one of a first process of evaluating the similarity between the wavelength characteristic (actually measured wavelength characteristic) indicated by the spectral information of the target pixel in the spectral image of Nch and the wavelength characteristic of the first subject indicated by the first subject spectral reflectance information I11 and a second process of evaluating the similarity between the wavelength characteristic indicated by the spectral information of the target pixel in the spectral image of Nch and the wavelength characteristic of the second subject indicated by the second subject spectral reflectance information I12 is performed to determine whether or not the subject is the first subject or the second subject.

For example, first, the first process is performed to determine whether or not the subject is the first subject. In a case where the subject is determined to be the first subject, the determination result that the subject is the first subject is confirmed. In a case where it is determined that the subject is not the first subject, the second process is performed to determine whether or not the subject is the second subject, and in a case where it is determined that the subject is the second subject, the determination result that the subject is the second subject is confirmed.

Note that the subject determination method based on the similarity evaluation result can be variously considered, and is not limited to the specific method. For example, there is a method in which both the first process and the second process are performed to obtain the similarity to the first subject and the similarity to the second subject, and the subject having the higher similarity is used as the determination result. In this case, it is conceivable to determine that the subject is neither the first subject nor the second subject if the similarity between both is equal to or less than the predetermined threshold.

Note that, regarding the first process and the second process, the actually measured wavelength characteristic is spectral information (light intensity for each wavelength), whereas the information serving as the evaluation reference of the similarity is spectral reflectance information (reflectance for each wavelength). Therefore, in the similarity evaluation, it is conceivable to perform normalization processing for making it possible to compare the two. Specifically, for example, the spectral reflectance information may be normalized to a value corresponding to the spectral information, or conversely, the spectral information may be normalized to a value corresponding to the spectral reflectance information.

In the narrow-band image generation unit 9B, the use coefficient switching unit 9a performs the above-described algorithm switching processing on the basis of the subject determination result by the subject determination unit 31. Specifically, the use coefficient switching unit 9a switches the narrow-band coefficient C used in the narrow-band processing such that the derived coefficient I5 is used in the narrow-band processing for the pixel in which the subject is determined to be the first subject by the subject determination unit 31 and the derived coefficient I6 is used in the narrow-band processing for the pixel in which the subject is determined to be the second subject by the subject determination unit 31.

According to the spectral camera 30B described above, since the subject determination is performed at a stage after the demosaic of the output of the spectral sensor 4 without undergoing the narrow-band processing, the subject determination can be performed at high speed.

### (4-2. Second Example)

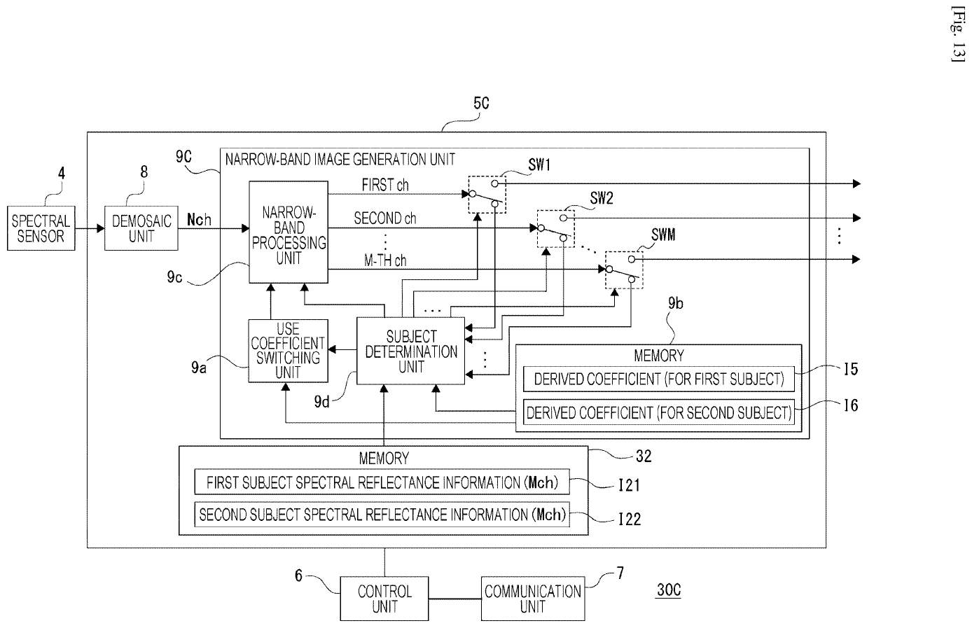

FIG. 13 is a block diagram illustrating a schematic configuration example of a spectral camera 30C as a second example of the third embodiment.

The spectral camera 30C is different from the spectral camera 30B illustrated in FIG. 12 in that a spectral image generation unit 5C is provided instead of the spectral image generation unit 5B.

The spectral image generation unit 5C is different in that a narrow-band image generation unit 9C is provided instead of the narrow-band image generation unit 9B and that the subject determination unit 31 is omitted.

The narrow-band image generation unit 9C is different from the narrow-band image generation unit 9B in that the narrow-band image generation unit 9C includes a subject determination unit 9d and M switches SW1, SW2, . . . , and SWM. Here, for the narrowband image generation unit 9C, a narrow-band processing unit 9c that performs the narrow-band processing is clearly illustrated.

Each switch SW is provided to switch between a subject determination mode in which the post-narrow-band spectral information of Mch obtained by the narrow-band processing unit 9c is input to the subject determination unit 9d and is not externally output and an output mode in which the post-narrow-band spectral information of the Mch is not input to the subject determination unit 9d and is externally output.

In the second example, since the subject determination is performed on the spectral information of Mch after the narrow-band processing, first subject spectral reflectance information I21 and second subject spectral reflectance information I22 with the wavelength resolution of Mch are stored in the memory 32.

In such a spectral camera 30C, the subject determination unit 9d first sets the subject determination mode by the control of each switch SW, and then sets any one of the derived coefficient I5 (for the first subject) and the derived coefficient I6 (for the second subject) stored in the memory 9b in the narrow-band processing unit 9c to execute the narrow-band processing. Then, if the derived coefficient I5 is set, the similarity to the post-narrow-band spectral information as the actually measured wavelength characteristic is evaluated with reference to the first subject spectral reflectance information I21 stored in the memory 32, and it is determined whether or not the subject of the target pixel is the first subject. If the derived coefficient I6 is set, the similarity to the post-narrow-band spectral information is evaluated with reference to the second subject spectral reflectance information I22 stored in the memory 32, and it is determined whether or not the subject of the target pixel is the second subject. By such processing, in a case where it is determined that the subject is the first subject or the second subject, the determination result is determined as the subject determination result of the target pixel. On the other hand, in a case where it is determined that the subject is not the first subject or the second subject by the above processing, the narrow-band processing unit 9c is caused to set the other of the derived coefficients I5 and I6 and execute the narrow-band processing, and similarly to the above, similarity evaluation is performed for the subject on the side of the set derived coefficient among the derived coefficients I5 and I6, and it is determined whether or not the subject of the target pixel is the subject on the side of the set derived coefficient among the derived coefficients I5 and I6.

Therefore, it is possible to appropriately determine whether or not the subject is the first subject or the second subject for each pixel using the actually measured wavelength characteristic of Mch after the narrow-band processing as a target.

According to the spectral camera 30C as the second example as described above, the subject determination is performed on the basis of the wavelength characteristic indicated by the wavelength resolution higher than the wavelength resolution of the spectral sensor 4, and thus, it is possible to realize highly accurate subject determination.

Note that, in the second embodiment, the subject determination for each unit area may be performed not only for two types of the first and second subjects but also for three or more types of subjects.

Furthermore, it is also conceivable to perform subject determination for each unit area using an AI model. In this case, the AI model is generated by machine learning in which the input data for learning is set as a sensor output (in the case of the first example) estimated on the basis of spectral reflectance information of the subject (one or a plurality of subjects) to be determined or post-narrow-band spectral information (in the case of the second example), and the training data is set as correct answer data of the type of the subject.

### 5. MODIFICATION

Further, the embodiments are not limited to the specific examples described above, and may be configured as various modifications.

For example, in the above description, an example has been described in which the information processing apparatus 1 (1A) acquires the subject spectral reflectance information I1, the light source spectral information I2, and the sensor spectral sensitivity information I3 used for the arithmetic algorithm derivation from the external database 2. However, it is also conceivable to adopt a configuration in which a storage device that stores the subject spectral reflectance information I1, the light source spectral information I2, and the sensor spectral sensitivity information I3 is provided in the information processing apparatus 1.

Furthermore, in the above description, the apparatus form of the spectral camera including the spectral sensor 4 has been exemplified as the apparatus form of the image processing apparatus according to the present technology, but the image processing apparatus according to the present technology may also take an apparatus form not including the spectral sensor 4 or the demosaic unit 8. For example, it is conceivable that the spectral sensor 4 is provided in an external device, and an output from the spectral sensor 4 is input to perform demosaic processing and narrow-band processing. Alternatively, a device form is conceivable in which the spectral sensor 4 and the demosaic unit 8 are provided in an external device, and the spectral image after the demosaic processing output from the external device is subjected to the narrowband processing.

### 6. PROGRAM

Here, as an embodiment, it is possible to consider a program for causing a CPU, a digital signal processor (DSP), or the like, or a device including the CPU, the digital signal processor (DSP), or the like, to implement the functions of the sensor input estimation unit F1, the sensor output estimation unit F2, the narrow-band processing unit F3, the coefficient derivation unit F4, and the like described with reference to FIG. 7, FIG. 10, or the like.

That is, the program according to the embodiment is a program that can be read by a computer device, and causes the computer device to realize a function of obtaining an arithmetic algorithm that minimizes an error between a wavelength characteristic indicated by post-narrow-band spectral information obtained by performing the narrow-band processing based on the sensor output and a wavelength characteristic indicated by the sensor input as an arithmetic algorithm of the narrow-band processing that is processing of estimating the sensor input that is spectral information of the input light to the spectral sensor on the basis of spectral reflectance information of the target subject and spectral information of the target light source, estimating the sensor output that is the spectral information output from the spectral sensor according to the sensor input on the basis of the spectral sensitivity information of the spectral sensor and the sensor input, and estimating the spectral information for a larger number of wavelengths than the number of output wavelengths of the spectral sensor on the basis of the output spectral information of the spectral sensor.

With such a program, the functions as the sensor input estimation unit F1, the sensor output estimation unit F2, the narrow-band processing unit F3, and the coefficient derivation unit F4 described above can be implemented in a device as the information processing apparatus 1 or the like.

Such a program can be recorded in advance in a hard disk drive (HDD) as a recording medium built in a device such as a computer device, a ROM in a microcomputer having a CPU, or the like.

Furthermore, the program can be temporarily or permanently stored (recorded) in a removable recording medium such as a flexible disk, a compact disk read only memory (CD-ROM), a magneto optical (MO) disk, a digital versatile disk (DVD), a Blu-ray disk (registered trademark), a magnetic disk, a semiconductor memory, or a memory card. Such a removable recording medium can be provided as so-called package software.

Furthermore, such a program can be installed from the removable recording medium into a personal computer or the like, or can be downloaded from a download site via a network such as a local area network (LAN) or the Internet.

Furthermore, such a program is suitable for providing an algorithm derivation method as an embodiment in a wide range. For example, by downloading the program to a mobile terminal device such as a personal computer, a portable information processing apparatus, a mobile phone, a game device, a video device, a personal digital assistant (PDA), or the like, the personal computer or the like can be caused to function as a device that achieves the algorithm derivation method of the present disclosure.

### 7. NOTES

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least lossless encoding and decoding using inverse orthogonal transforms in an image processing system.

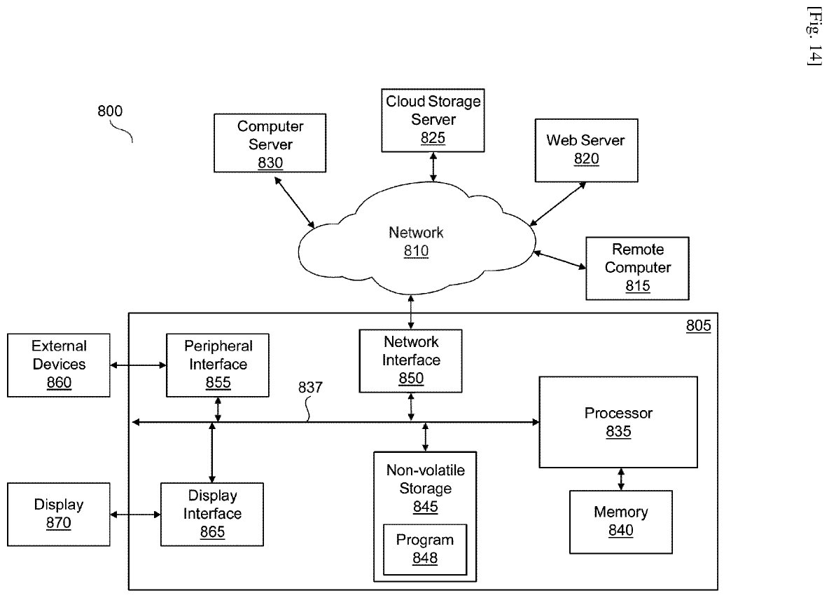

FIG. 14 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A nonexhaustive list of more specific examples of the computer readable storage medium includes each of the following (and appropriate combinations): flexible disk, hard disk, solid-state drive (SSD), random access memory (RAM), read-only memory (ROM), erasable programmable readonly memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or compute server, or any combination of these computing devices. The remote computer or compute server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 14 is a functional block diagram illustrating a networked system 800 of one or more networked computers and servers. In an embodiment, the hardware and software environment illustrated in FIG. 14 may provide an exemplary platform for implementation of the software and/or methods according to the present disclosure.

Referring to FIG. 14, a networked system 800 may include, but is not limited to, computer 805, network 810, remote computer 815, web server 820, cloud storage server 825 and compute server 830. In some embodiments, multiple instances of one or more of the functional blocks illustrated in FIG. 14 may be employed.

Additional detail of computer 805 is shown in FIG. 14. The functional blocks illustrated within computer 805 are provided only to establish exemplary functionality and are not intended to be exhaustive. And while details are not provided for remote computer 815, web server 820, cloud storage server 825 and compute server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and compute server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

Combination of connections and protocols that support communications between two or more computers and related devices.

Obviously, numerous modifications and variations of the present invention are possible in light of the above teachings. It is therefore to be understood that within the scope of the appended claims, the invention may be practiced otherwise than as specifically described herein.

### 8. CONCLUSION OF EMBODIMENTS

As described above, an information processing apparatus (reference numerals 1 and 1A) as the embodiment includes: a sensor input estimation unit (reference numeral F1) that estimates a sensor input that is spectral information of input light to a spectral sensor (reference numeral 4) on a basis of spectral reflectance information of a target subject and spectral information of a target light source, a sensor output estimation unit (reference numeral F2) that estimates a sensor output that is spectral information output by the spectral sensor according to the sensor input on a basis of spectral sensitivity information of the spectral sensor and the sensor input, and a derivation processing unit (the narrow-band processing unit F3 and the coefficient derivation unit F4) that obtains an arithmetic algorithm that minimizes an error (reference numeral D) between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor.

As described above, the arithmetic algorithm used in the narrow-band processing is obtained by the error minimization processing in which the wavelength characteristic of the sensor input is set as a target value, whereby the spectral sensitivity variation of the spectral sensor can be compensated if the light source and the subject are of the assumed object type by performing the narrow-band processing using the arithmetic algorithm. Then, since the arithmetic algorithm is derived so that the error between the post-narrow-band spectral information of the sensor output and the sensor input is minimized as described above, both the post-narrow-band spectral information of the sensor output and the sensor input can be the information of the wavelength resolution (resolution of Mch) after the narrow-band processing, and thus, it is possible to compensate for the spectral sensitivity variation with the accuracy of the number of wavelengths after the narrow-band processing.

Therefore, accuracy of spectral sensitivity variation compensation of the spectral sensor can be improved, and spectral performance of the spectral camera can be improved.

Furthermore, in the information processing apparatus as an embodiment, the narrowband processing is performed by matrix calculation based on the sensor output, and the derivation processing unit obtains a coefficient of the matrix calculation such that an error between a wavelength characteristic indicated by the post-narrow-band spectral information and a wavelength characteristic indicated by the sensor input is minimized (see FIGS. 7 and 10, etc.).

Therefore, a coefficient for performing spectral sensitivity variation compensation can be obtained corresponding to a case where the narrow-band processing is performed by matrix calculation based on the sensor output.

Moreover, in the information processing apparatus as an embodiment, a plurality of the target subjects is provided, the sensor input estimation unit estimates the sensor input for each of the target subjects on a basis of spectral reflectance information of the plurality of target subjects and spectral information of the target light source, the sensor output estimation unit estimates the sensor output for each of the target subjects on a basis of the sensor input for each of the target subjects, and the derivation processing unit estimates the post-narrow-band spectral information for each of the target subjects on a basis of the sensor output for each of the target subjects, calculates the error for each of the target subjects on a basis of the estimated post-narrow-band spectral information for each of the target subjects and the sensor input, and obtains a set of the coefficients on the basis of the calculated error for each of the target subjects.

Therefore, it is possible to obtain a set of coefficients capable of performing appropriate spectral sensitivity variation compensation corresponding to a plurality of types of subjects without being specialized only for one type of subject. That is, by performing the narrow-band processing using the set of coefficients on the spectral camera side, appropriate spectral sensitivity variation compensation can be performed corresponding to a plurality of types of subjects.

Moreover, in the information processing apparatus as an embodiment, a plurality of the target light sources is provided, the sensor input estimation unit estimates the sensor input for each of the target light sources on the basis of spectral reflectance information of the target subject and spectral information of the plurality of target light sources, the sensor output estimation unit estimates the sensor output for each of the target light sources on the basis of the sensor input for each of the target light sources, and the derivation processing unit estimates the post-narrow-band spectral information for each of the target light sources on the basis of the sensor output for each of the target light sources, calculates the error for each of the target light sources on the basis of the estimated post-narrow-band spectral information for each of the target light sources and the sensor input, and obtains a set of the coefficients on the basis of the calculated error for each of the target light sources.

Therefore, it is possible to obtain a set of coefficients capable of performing appropriate spectral sensitivity variation compensation corresponding to a plurality of types of light sources without being specialized only for one type of light source. That is, by performing the narrow-band processing using the set of coefficients on the spectral camera side, appropriate spectral sensitivity variation compensation can be performed for a plurality of types of light sources.

Furthermore, in the information processing apparatus as an embodiment, a plurality of the target subjects and a plurality of the target light sources are provided, the sensor input estimation unit estimates the sensor input for each combination of the target subject and the target light source on the basis of spectral reflectance information of a plurality of the target subjects and spectral information of a plurality of the target light sources, the sensor output estimation unit estimates the sensor output for each of the combinations on the basis of the sensor input for each of the combinations, and the derivation processing unit estimates the post-narrow-band spectral information for each of the combinations on the basis of the sensor output for each of the combinations, calculates the error for each of the combinations on the basis of the estimated post-narrow-band spectral information for each of the combinations and the sensor input, and obtains a set of the coefficients on the basis of the calculated error for each of the combinations.

Therefore, it is possible to obtain a set of coefficients capable of performing appropriate spectral sensitivity variation compensation corresponding to a combination of a plurality of types of subjects and light sources without being specialized only for one type of subject and light source. That is, by performing the narrow-band processing using the set of coefficients on the spectral camera side, it is possible to perform appropriate spectral sensitivity variation compensation corresponding to a combination of a plurality of types of subjects and light sources.

Moreover, in the information processing apparatus (reference numeral 1A) as an embodiment, a set of spectral reflectance information of a target subject and spectral information of a target light source is selected from a storage device (database 2) in which a set of spectral reflectance information of a target subject and spectral information of a target light source is stored for each application that performs subject analysis based on spectral information, according to a selection operation of the application by a user, and the selected spectral reflectance information of the target subject and the selected spectral information of the target light source are used for a process of obtaining the arithmetic algorithm (see FIG. 9).

Therefore, in deriving the arithmetic algorithm suitable for the application, it is not necessary for the user to specify the combination of the target subject and the target light source, and it is sufficient to perform only the selection operation of the application.

Therefore, it is possible to reduce the operation burden on the user in deriving the arithmetic algorithm suitable for the application.

An information processing method as an embodiment is an information processing method that is performed by an information processing apparatus, the method including: estimating a sensor input that is spectral information of input light to a spectral sensor on a basis of spectral reflectance information of a target subject and spectral information of a target light source; estimating a sensor output that is spectral information output by the spectral sensor according to the sensor input on a basis of spectral sensitivity information of the spectral sensor and the sensor input; and obtaining an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor.

With such an information processing method, functions and effects similar to functions and effects of the information processing apparatus as the embodiment described above can also be obtained.

The program as an embodiment is a program that can be read by a computer device, and causes the computer device to realize a function of obtaining an arithmetic algorithm that minimizes an error between a wavelength characteristic indicated by post-narrow-band spectral information obtained by performing the narrow-band processing based on the sensor output and a wavelength characteristic indicated by the sensor input as an arithmetic algorithm of the narrow-band processing that is processing of estimating the sensor input that is spectral information of the input light to the spectral sensor on the basis of spectral reflectance information of the target subject and spectral information of the target light source, estimating the sensor output that is the spectral information output from the spectral sensor according to the sensor input on the basis of the spectral sensitivity information of the spectral sensor and the sensor input, and estimating the spectral information for a larger number of wavelengths than the number of output wavelengths of the spectral sensor on the basis of the output spectral information of the spectral sensor.

With such a program, the information processing apparatus as the embodiment described above can be achieved.

An image processing apparatus (spectral cameras 30, 30B, 30C) as an embodiment uses an arithmetic algorithm obtained by an information processing apparatus (reference numerals 1 and 1A), the information processing apparatus including a sensor input estimation unit that estimates a sensor input that is spectral information of input light to a spectral sensor on a basis of spectral reflectance information of a target subject and spectral information of a target light source; a sensor output estimation unit that estimates a sensor output that is spectral information output by the spectral sensor according to the sensor input on a basis of spectral sensitivity information of the spectral sensor and the sensor input; and a derivation processing unit that obtains an arithmetic algorithm that minimizes an error between a wavelength characteristic indicated by post-narrow-band spectral information obtained by performing narrowband processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor. The image processing apparatus includes: a spectral image generation unit (reference numerals 5, 5B, 5C) that generates a narrow-band image with respect to a larger number of wavelengths than a number of output wavelengths of the spectral sensor by performing the narrow-band processing based on an output of the spectral sensor (reference numeral 4).

The arithmetic algorithm obtained by the information processing apparatus as described above is an arithmetic algorithm that can obtain spectral information in which a spectral sensitivity variation is compensated for as long as a light source and a subject are of an assumed subject type by performing narrow-band processing using the arithmetic algorithm.

Therefore, according to the image processing apparatus as an embodiment that performs the narrow-band processing using such an arithmetic algorithm, it is possible to improve the accuracy of the spectral sensitivity variation compensation and to improve the spectral performance of the spectral camera as compared with the past case where the processing for the spectral sensitivity variation compensation is performed on the sensor output.

Furthermore, the image processing apparatus (spectral cameras 30B, 30C) as an embodiment includes a subject determination unit (reference numerals 31, 9d) that evaluates, for each unit area of a spectral image obtained by demosaicing an output of the spectral sensor, similarity between an actually measured wavelength characteristic that is a wavelength characteristic of spectral information obtained on a basis of an output of the spectral sensor and a wavelength characteristic of the target subject, and determines, for each of the unit areas, whether or not a subject is the target subject on a basis of an evaluation result of the similarity (see FIGS. 12 and 13).

Therefore, this eliminates the need to perform complicated image analysis processing such as subject recognition processing using the AI model and rule-based subject recognition processing by template matching of the subject or the like on the basis of the captured image of the image sensor provided separately from the spectral sensor, and the subject recognition processing for the previously assumed target subject can be realized with simple processing.

Moreover, in the image processing apparatus as an embodiment, the information processing apparatus obtains the arithmetic algorithm corresponding to each of a first subject and a second subject that are the target subjects of different types, the subject determination unit determines whether or not a subject is the first subject or the second subject for each of the unit areas by performing at least one of a first process of evaluating similarity between the actually measured wavelength characteristic and a wavelength characteristic of the first subject and a second process of evaluating similarity between the actually measured wavelength characteristic and a wavelength characteristic of the second subject for each of the unit areas, and the image processing apparatus further includes: a switching processing unit (use coefficient switching unit 9a) that switches the arithmetic algorithm such that the arithmetic algorithm obtained corresponding to the first subject is used in the narrow-band processing for the unit area in which a subject is determined to be the first subject by the subject determination unit, and the arithmetic algorithm obtained corresponding to the second subject is used in the narrow-band processing for the unit area in which a subject is determined to be the second subject by the subject determination unit.

Therefore, in a case where different subjects are captured within the angle of view, it is possible to perform the narrow-band processing with an arithmetic algorithm suitable for each subject.

Therefore, spectral information can be obtained with high accuracy for each subject. Moreover, in the image processing apparatus (spectral camera 30B) as the embodiment, the subject determination unit (same 31) evaluates, as an evaluation of the similarity, similarity between a wavelength characteristic of spectral information for each of the unit areas in a spectral image obtained by demosaicing an output of the spectral sensor and a wavelength characteristic of the target subject based on wavelength resolution of the spectral sensor.

Since the subject determination is performed at a stage after the demosaic of the output of the spectral sensor without undergoing the narrow-band processing, the subject determination can be performed at high speed.

Furthermore, in the image processing apparatus (spectral camera 30C) as the embodiment, the subject determination unit (reference numeral 9d) evaluates, as an evaluation of the similarity, similarity between a wavelength characteristic indicated by post-narrow-band spectral information obtained by performing the narrow-band processing based on an output of the spectral sensor using the arithmetic algorithm corresponding to the target subject and a wavelength characteristic of the target subject based on wavelength resolution of the post-narrow-band spectral information.

Therefore, the subject determination is performed on the basis of the wavelength characteristic indicated by the wavelength resolution higher than the wavelength resolution of the spectral sensor, and thus, it is possible to realize highly accurate subject determination.

In an image processing method as an embodiment that is performed by an image processing apparatus, the image processing apparatus using an arithmetic algorithm obtained by an information processing apparatus, the information processing apparatus including a sensor input estimation unit that estimates a sensor input that is spectral information of input light to a spectral sensor on a basis of spectral reflectance information of a target subject and spectral information of a target light source; a sensor output estimation unit that estimates a sensor output that is spectral information output by the spectral sensor according to the sensor input on a basis of spectral sensitivity information of the spectral sensor and the sensor input; and a derivation processing unit that obtains an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor, the method includes: generating a narrow-band image with respect to a larger number of wavelengths than a number of output wavelengths of the spectral sensor by performing the narrow-band processing based on an output of the spectral sensor.

According to even such an image processing method, it is possible to obtain functions and effects similar to those of the image processing apparatus as the above-described embodiment.

Note that effects described in the present description are merely examples and are not limited, and other effects may be provided.

### 9. PRESENT TECHNOLOGY

The present technology can also adopt the following configurations.
(1)
An information processing apparatus including:
a sensor input estimation unit that estimates a sensor input that is spectral information of input light to a spectral sensor on the basis of spectral reflectance information of a target subject and spectral information of a target light source;
a sensor output estimation unit that estimates a sensor output that is spectral information output by the spectral sensor according to the sensor input on the basis of spectral sensitivity information of the spectral sensor and the sensor input; and
a derivation processing unit that obtains an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on the basis of the output spectral information of the spectral sensor.
(2)
The information processing apparatus according to (1), in which
the narrow-band processing is performed by matrix calculation based on the sensor output, and
the derivation processing unit obtains a coefficient of the matrix calculation such that an error between a wavelength characteristic indicated by the post-narrow-band spectral information and a wavelength characteristic indicated by the sensor input is minimized.
(3)
The information processing apparatus according to (2), in which
a plurality of the target subjects is provided,
the sensor input estimation unit estimates the sensor input for each of the target subjects on the basis of spectral reflectance information of the plurality of target subjects and spectral information of the target light source,
the sensor output estimation unit estimates the sensor output for each of the target subjects on the basis of the sensor input for each of the target subjects, and the derivation processing unit estimates the post-narrow-band spectral information for each of the target subjects on the basis of the sensor output for each of the target subjects, calculates the error for each of the target subjects on the basis of the estimated post-narrow-band spectral information for each of the target subjects and the sensor input, and obtains a set of the coefficients on the basis of the calculated error for each of the target subjects.
(4)
The information processing apparatus according to (2), in which
a plurality of the target light sources is provided,
the sensor input estimation unit estimates the sensor input for each of the target light sources on the basis of spectral reflectance information of the target subject and spectral information of the plurality of target light sources,
the sensor output estimation unit estimates the sensor output for each of the target light sources on the basis of the sensor input for each of the target light sources, and
the derivation processing unit estimates the post-narrow-band spectral information for each of the target light sources on the basis of the sensor output for each of the target light sources, calculates the error for each of the target light sources on the basis of the estimated post-narrow-band spectral information for each of the target light sources and the sensor input, and obtains a set of the coefficients on the basis of the calculated error for each of the target light sources.
(5)
The information processing apparatus according to (2), in which
a plurality of the target subjects and a plurality of the target light sources are provided, the sensor input estimation unit estimates the sensor input for each combination of the target subject and the target light source on the basis of spectral reflectance information of a plurality of the target subjects and spectral information of a plurality of the target light sources,
the sensor output estimation unit estimates the sensor output for each of the combinations on the basis of the sensor input for each of the combinations, and
the derivation processing unit estimates the post-narrow-band spectral information for each of the combinations on the basis of the sensor output for each of the combinations, calculates the error for each of the combinations on the basis of the estimated post-narrow-band spectral information for each of the combinations and the sensor input, and obtains a set of the coefficients on the basis of the calculated error for each of the combinations.
(6)
The information processing apparatus according to any one of (1) to (5), in which a set of spectral reflectance information of a target subject and spectral information of a target light source is selected from a storage device in which a set of spectral reflectance information of a target subject and spectral information of a target light source is stored for each application that performs subject analysis based on spectral information, according to a selection operation of the application by a user, and the selected spectral reflectance information of the target subject and the selected spectral information of the target light source are used for a process of obtaining the arithmetic algorithm.
(7)
An information processing method that is performed by an information processing apparatus, the method including:
estimating a sensor input that is spectral information of input light to a spectral sensor on a basis of spectral reflectance information of a target subject and spectral information of a target light source;
estimating a sensor output that is spectral information output by the spectral sensor according to the sensor input on a basis of spectral sensitivity information of the spectral sensor and the sensor input; and
obtaining an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor.
(8)
A program readable by a computer device, the program causing the computer device to realize a function of:
estimating a sensor input that is spectral information of input light to a spectral sensor on the basis of spectral reflectance information of a target subject and spectral information of a target light source;
estimating a sensor output that is spectral information output by the spectral sensor according to the sensor input on the basis of spectral sensitivity information of the spectral sensor and the sensor input; and
obtaining an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on the basis of the output spectral information of the spectral sensor.
(9)
An image processing apparatus that uses an arithmetic algorithm obtained by an information processing apparatus, the information processing apparatus including a sensor input estimation unit that estimates a sensor input that is spectral information of input light to a spectral sensor on the basis of spectral reflectance information of a target subject and spectral information of a target light source; a sensor output estimation unit that estimates a sensor output that is spectral information output by the spectral sensor according to the sensor input on the basis of spectral sensitivity information of the spectral sensor and the sensor input; and a derivation processing unit that obtains an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on the basis of the output spectral information of the spectral sensor, the image processing apparatus including:
a spectral image generation unit that generates a narrow-band image with respect to a larger number of wavelengths than a number of output wavelengths of the spectral sensor by performing the narrow-band processing based on an output of the spectral sensor.
(10)
The image processing apparatus according to (9), further including:
a subject determination unit that evaluates, for each unit area of a spectral image obtained by demosaicing an output of the spectral sensor, similarity between an actually measured wavelength characteristic that is a wavelength characteristic of spectral information obtained on the basis of an output of the spectral sensor and a wavelength characteristic of the target subject, and determines, for each of the unit areas, whether or not a subject is the target subject on the basis of an evaluation result of the similarity.
(11)
The image processing apparatus according to (10), in which
the information processing apparatus obtains the arithmetic algorithm corresponding to each of a first subject and a second subject that are the target subjects of different types,
the subject determination unit determines whether or not a subject is the first subject or the second subject for each of the unit areas by performing at least one of a first process of evaluating similarity between the actually measured wavelength characteristic and a wavelength characteristic of the first subject and a second process of evaluating similarity between the actually measured wavelength characteristic and a wavelength characteristic of the second subject for each of the unit areas, and the image processing apparatus further includes:
a switching processing unit that switches the arithmetic algorithm such that the arithmetic algorithm obtained corresponding to the first subject is used in the narrowband processing for the unit area in which a subject is determined to be the first subject by the subject determination unit, and the arithmetic algorithm obtained corresponding to the second subject is used in the narrow-band processing for the unit area in which a subject is determined to be the second subject by the subject determination unit.
(12)
The image processing apparatus according to (10) or (11), in which
the subject determination unit evaluates, as an evaluation of the similarity, similarity between a wavelength characteristic of spectral information for each of the unit areas in a spectral image obtained by demosaicing an output of the spectral sensor and a wavelength characteristic of the target subject based on wavelength resolution of the spectral sensor.
(13)
The image processing apparatus according to (10) or (11), in which
the subject determination unit evaluates, as an evaluation of the similarity, similarity between a wavelength characteristic indicated by post-narrow-band spectral information obtained by performing the narrow-band processing based on an output of the spectral sensor using the arithmetic algorithm corresponding to the target subject and a wavelength characteristic of the target subject based on wavelength resolution of the post-narrow-band spectral information.
(14)
An image processing method that is performed by an image processing apparatus, the image processing apparatus using an arithmetic algorithm obtained by an information processing apparatus, the information processing apparatus including a sensor input estimation unit that estimates a sensor input that is spectral information of input light to a spectral sensor on the basis of spectral reflectance information of a target subject and spectral information of a target light source; a sensor output estimation unit that estimates a sensor output that is spectral information output by the spectral sensor according to the sensor input on the basis of spectral sensitivity information of the spectral sensor and the sensor input; and a derivation processing unit that obtains an arithmetic algorithm that minimizes an error between a wavelength characteristic indicated by post-narrow-band spectral information obtained by performing narrowband processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on the basis of the output spectral information of the spectral sensor,
the method including:
generating a narrow-band image with respect to a larger number of wavelengths than a number of output wavelengths of the spectral sensor by performing the narrow-band processing based on an output of the spectral sensor.
   It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1, 1A Information processing apparatus
2 Database
3 Spectral camera
4 Spectral sensor
4a Pixel array unit
5, 5B, 5C Spectral image generation unit
6 Control unit
7 Communication unit
8 Demosaic unit
9, 9B, 9C Narrow-band image generation unit
Px Pixel
Pu Spectral pixel unit
I1 Subject spectral reflectance information
I2 Light source spectral information
I3 Sensor spectral sensitivity information
10, 10A Arithmetic unit
11 Operation unit
12 Communication unit
F1 Sensor input estimation unit
F2 Sensor output estimation unit
F3 Narrow-band processing unit
F4 Coefficient derivation unit
30, 30B, 30C Spectral camera
S1, S2 Subject
9a Use coefficient switching unit
9b Memory
9c Narrow-band processing unit
9d Subject determination unit
31 Subject determination unit
32 Memory
I5 Derivation coefficient (for first subject)
I6 Derivation coefficient (for second subject)
I11 First subject spectral reflectance information (Nch)
I12 Second subject spectral reflectance information (Nch)
I21 First subject spectral reflectance information (Mch)
I22 Second subject spectral reflectance information (Mch)

1. An information processing apparatus comprising:
a sensor input estimation unit that estimates a sensor input that is spectral information of input light to a spectral sensor on a basis of spectral reflectance information of a target subject and spectral information of a target light source;
a sensor output estimation unit that estimates a sensor output that is spectral information output by the spectral sensor according to the sensor input on a basis of spectral sensitivity information of the spectral sensor and the sensor input; and
a derivation processing unit that obtains an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor.

2. The information processing apparatus according to claim 1, wherein
the narrow-band processing is performed by matrix calculation based on the sensor output, and
the derivation processing unit obtains a coefficient of the matrix calculation such that an error between a wavelength characteristic indicated by the post-narrow-band spectral information and a wavelength characteristic indicated by the sensor input is minimized.

3. The information processing apparatus according to claim 2, wherein
a plurality of the target subjects is provided,
the sensor input estimation unit estimates the sensor input for each of the target subjects on a basis of spectral reflectance information of the plurality of target subjects and spectral information of the target light source,
the sensor output estimation unit estimates the sensor output for each of the target subjects on a basis of the sensor input for each of the target subjects, and
the derivation processing unit estimates the post-narrow-band spectral information for each of the target subjects on a basis of the sensor output for each of the target subjects, calculates the error for each of the target subjects on a basis of the estimated post-narrow-band spectral information for each of the target subjects and the sensor input, and obtains a set of the coefficients on a basis of the calculated error for each of the target subjects.

4. The information processing apparatus according to claim 2, wherein
a plurality of the target light sources is provided,
the sensor input estimation unit estimates the sensor input for each of the target light sources on a basis of spectral reflectance information of the target subject and spectral information of the plurality of target light sources,
the sensor output estimation unit estimates the sensor output for each of the target light sources on a basis of the sensor input for each of the target light sources, and
the derivation processing unit estimates the post-narrow-band spectral information for each of the target light sources on a basis of the sensor output for each of the target light sources, calculates the error for each of the target light sources on a basis of the estimated post-narrow-band spectral information for each of the target light sources and the sensor input, and obtains a set of the coefficients on a basis of the calculated error for each of the target light sources.

5. The information processing apparatus according to claim 2, wherein
a plurality of the target subjects and a plurality of the target light sources are provided,
the sensor input estimation unit estimates the sensor input for each combination of the target subject and the target light source on a basis of spectral reflectance information of a plurality of the target subjects and spectral information of a plurality of the target light sources,
the sensor output estimation unit estimates the sensor output for each of the combinations on a basis of the sensor input for each of the combinations, and
the derivation processing unit estimates the post-narrow-band spectral information for each of the combinations on a basis of the sensor output for each of the combinations, calculates the error for each of the combinations on a basis of the estimated post-narrow-band spectral information for each of the combinations and the sensor input, and obtains a set of the coefficients on a basis of the calculated error for each of the combinations.

6. The information processing apparatus according to claim 1, wherein
a set of spectral reflectance information of a target subject and spectral information of a target light source is selected from a storage device in which a set of spectral reflectance information of a target subject and spectral information of a target light source is stored for each application that performs subject analysis based on spectral information, according to a selection operation of the application by a user, and the selected spectral reflectance information of the target subject and the selected spectral information of the target light source are used for a process of obtaining the arithmetic algorithm.

7. An information processing method that is performed by an information processing apparatus, the method comprising:
estimating a sensor input that is spectral information of input light to a spectral sensor on a basis of spectral reflectance information of a target subject and spectral information of a target light source;
estimating a sensor output that is spectral information output by the spectral sensor according to the sensor input on a basis of spectral sensitivity information of the spectral sensor and the sensor input; and
obtaining an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor.

8. A program readable by a computer device, the program causing the computer device to realize a function of:
estimating a sensor input that is spectral information of input light to a spectral sensor on a basis of spectral reflectance information of a target subject and spectral information of a target light source;
estimating a sensor output that is spectral information output by the spectral sensor according to the sensor input on a basis of spectral sensitivity information of the spectral sensor and the sensor input; and
obtaining an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor.

9. An image processing apparatus that uses an arithmetic algorithm obtained by an information processing apparatus, the information processing apparatus including a sensor input estimation unit that estimates a sensor input that is spectral information of input light to a spectral sensor on a basis of spectral reflectance information of a target subject and spectral information of a target light source; a sensor output estimation unit that estimates a sensor output that is spectral information output by the spectral sensor according to the sensor input on a basis of spectral sensitivity information of the spectral sensor and the sensor input; and a derivation processing unit that obtains an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor,
the image processing apparatus comprising:
a spectral image generation unit that generates a narrow-band image with respect to a larger number of wavelengths than a number of output wavelengths of the spectral sensor by performing the narrow-band processing based on an output of the spectral sensor.

10. The image processing apparatus according to claim 9, further comprising:
a subject determination unit that evaluates, for each unit area of a spectral image obtained by demosaicing an output of the spectral sensor, similarity between an actually measured wavelength characteristic that is a wavelength characteristic of spectral information obtained on a basis of an output of the spectral sensor and a wavelength characteristic of the target subject, and determines, for each of the unit areas, whether or not a subject is the target subject on a basis of an evaluation result of the similarity.

11. The image processing apparatus according to claim 10, wherein
the information processing apparatus obtains the arithmetic algorithm corresponding to each of a first subject and a second subject that are the target subjects of different types,
the subject determination unit determines whether or not a subject is the first subject or the second subject for each of the unit areas by performing at least one of a first process of evaluating similarity between the actually measured wavelength characteristic and a wavelength characteristic of the first subject and a second process of evaluating similarity between the actually measured wavelength characteristic and a wavelength characteristic of the second subject for each of the unit areas, and
the image processing apparatus further comprises:
a switching processing unit that switches the arithmetic algorithm such that the arithmetic algorithm obtained corresponding to the first subject is used in the narrow-band processing for the unit area in which a subject is determined to be the first subject by the subject determination unit, and the arithmetic algorithm obtained corresponding to the second subject is used in the narrow-band processing for the unit area in which a subject is determined to be the second subject by the subject determination unit.

12. The image processing apparatus according to claim 10, wherein
the subject determination unit evaluates, as an evaluation of the similarity, similarity between a wavelength characteristic of spectral information for each of the unit areas in a spectral image obtained by demosaicing an output of the spectral sensor and a wavelength characteristic of the target subject based on wavelength resolution of the spectral sensor.

13. The image processing apparatus according to claim 10, wherein
the subject determination unit evaluates, as an evaluation of the similarity, similarity between a wavelength characteristic indicated by post-narrow-band spectral information obtained by performing the narrow-band processing based on an output of the spectral sensor using the arithmetic algorithm corresponding to the target subject and a wavelength characteristic of the target subject based on wavelength resolution of the post-narrow-band spectral information.

14. An image processing method that is performed by an image processing apparatus, the image processing apparatus using an arithmetic algorithm obtained by an information processing apparatus, the information processing apparatus including a sensor input estimation unit that estimates a sensor input that is spectral information of input light to a spectral sensor on a basis of spectral reflectance information of a target subject and spectral information of a target light source; a sensor output estimation unit that estimates a sensor output that is spectral information output by the spectral sensor according to the sensor input on a basis of spectral sensitivity information of the spectral sensor and the sensor input; and a derivation processing unit that obtains an arithmetic algorithm that minimizes an error between a wavelength characteristic indicated by post-narrow-band spectral information obtained by performing narrow-band processing based on the sensor output and a wavelength characteristic indicated by the sensor input as an arithmetic algorithm of the narrow-band processing that is processing of estimating spectral information on a larger number of wavelengths than a number of output wavelengths of the spectral sensor on a basis of the output spectral information of the spectral sensor,
the method comprising:
generating a narrow-band image with respect to a larger number of wavelengths than a number of output wavelengths of the spectral sensor by performing the narrow-band processing based on an output of the spectral sensor.
